(19) United States
(12) Patent Application Publication
(10) Pub. No.: US 2021/0275929 A1
(43) Pub. Date: Sep. 9, 2021

(54) ELECTRONIC FINANCIAL TRANSACTIONS FOR GAMING ENVIRONMENTS

(71) Applicant: AUTOMATED CASHLESS SYSTEMS, INC., Reno, NV (US)

(72) Inventors: Stephen L. Warner, Zephyr Cove, NV (US); Michael Sackrison, Reno, NV (US); Shawn G. Quick, Reno, NV (US)

(21) Appl. No.: 17/185,899

(22) Filed: Feb. 25, 2021

Related U.S. Application Data
(63) Continuation-in-part of application No. 15/212,020, filed on Jul. 15, 2016.
(60) Provisional application No. 62/193,586, filed on Jul. 17, 2015.

(51) Int. Cl. A63F 13/792

(52) U.S. Cl. CPC A63F 13/792

(57) ABSTRACT

A system and method for enabling financial transactions in a casino are described. The transactional system includes an electronic funds transfer (EFT) terminal, a networkable component, a financial network, and a Casino Management System (CMS). The networkable component includes one or more gaming limit and gaming rule software modules that operate to regulate requested transactions. At least one gaming limit included on the networkable component is configurable by each licensee casino and/or individual patron. The networkable component retrieves transaction information related to a fund transfer request. The networkable component can then independently determine that the fund transfer request complies with the applicable configurable limits, gaming limits, and gaming rules. Compliant transactions that are approved by the financial network(s) are submitted to the CMS by the networkable component for generation of a corresponding voucher validation code or other indicia of value.

### CROSS REFERENCE

This patent application is a Continuation-In-Part of patent application Ser. No. 15/212,020 entitled FINANCIAL TRANSACTIONAL GATEWAY SYSTEMS AND METHODS, filed on Jul. 15, 2016,

which claims the benefit of provisional patent application 62/193,586 entitled GAMING GATEWAY SYSTEM AND METHOD filed on Jul. 17, 2015;

and all the patent applications identified above are incorporated by reference in this patent application filing.

### FIELD

The present disclosure relates to financial transaction gateway systems and methods incorporating configurable transaction limits. More specifically, the financial transaction gateway systems and methods evaluate compliance of a requested transaction with the configurable transaction limits.

### BACKGROUND

In everyday retail POS transactions, a merchant uses software that automatically transmits an authorization request to a credit or debit card processor which routes that request to the proper banking network. Because the banks essentially own the cards that the consumer uses, the banks then make a decision based on various factors relating to the transaction, such as amount, location, and/or daily limits to make a decision on whether the transaction request is approved or denied. In some cases, even an ‘overdraft’ is allowed because the bank deems the customer credit worthy and will approve the transaction even though the customer's account will become overdrawn. Typically, this also results in an overdraft fee charged to the customer.

Most casinos provide automated teller machines (ATM) and cash kiosks for the convenience of their patrons. However, these devices require floor space and often create a queue of patrons waiting in line to use the machines. Generally, these devices are dedicated machines that dispense cash to patrons and are usually located around the periphery of the casino floor. These devices are intended to be operated at one location and are not easily relocated. These devices also force players to travel to the location of the machine.

Additionally, existing unattended cash machines are expensive and may require considerable attention from gaming establishment personnel. Such machines must be continually restocked with large quantities of cash due to the near-continual use by patrons, which may also result in an increased frequency of machine failure.

Casino chips are commonly used at gaming tables in the casino property. Patrons may obtain chips for cash when beginning or continuing play at a table, but such purchases are limited to cash on hand and many players are reluctant to carry a large quantity of cash on their person. Patrons seeking to complete an electronic funds transfer (EFT) must therefore leave their table gaming station and seek out an ATM, cash kiosk, or often stand in line at the casino cashier's cage to perform that operation. Further, the patron may only be able to directly receive cash as the result of an EFT. To participate in most table games, the patron must then convert the cash into casino chips at either the cashier's cage or at the gaming table. Faced with the inconvenience of completing this two-step process, a patron may decide to stop playing, reducing the entertainment value of his gaming experience while simultaneously reducing revenue for the gaming establishment.

Automated Cash Systems, Inc. (ACS) has extended the reach of ATMs and kiosks to table games. More specifically, ACS provides a point-of-sale (POS) personal identification number (PIN) debit fund processing system for gaming patrons at table games. The ACS system provides a secure system that allows gaming patrons to initiate and complete an electronic transfer of funds from a bank or credit account entirely at the point of game play.

In the casino gaming space, there are many additional and varying regulations regarding all matters related to the operation of casinos, and the manufacture of devices used in casinos. These regulations are necessary in order to protect the consumer, the casinos and the reputation of the industry.

With respect to the customer, there are many challenges and concerns associated with “problem gaming.” Problem gaming may be referred to as a psychological condition, an impulse disorder, or simply an addiction. There are an estimated 1%-2% of those players that gamble that have a gaming problem as reported by the “National Center for Responsible Gaming” (NCRG).

Regulations also vary across the country and the world, as there is no federal or international regulation of the casino gaming space outside of online gaming. In the United States, each state is responsible for its own gaming regulations. Although many states have similar requirements, there are many differences in what those regulations allow, what devices may be used, and how those devices can be used. Further complicating the issue is the concept of the ‘sovereign nation’ status granted to Native American tribes by the Federal government that allows the tribes to regulate their own casinos within each state. This provides a greater number of bodies creating and enforcing casino gaming regulations.

Standard off the shelf POS hardware and software have only been designed to meet banking requirements. In addition, the ATM machines allowed on-site by casinos allow a customer to withdraw funds from his/her credit or debit card account, but provide no ‘gaming regulatory’ inspection or decision-making to obtain an approval. The machines simply provide cash if the customer's bank approves the transaction.

Gaming establishments are highly motivated to accommodate their patrons and increase player satisfaction. Thus, there is a need for a simplified method for a gaming patron to utilize their own instrument in a payment device located proximate to or at a table game, which can easily integrate with existing legacy casino gaming systems and meet the stringent security and regulatory requirements for casino gaming. Further, it would be beneficial to provide a secure system that allows gaming patrons to initiate and complete an electronic transfer of funds from a bank or credit account entirely at the point of game play, i.e. a table game.

### SUMMARY

A system and a method for enabling financial transactions at a table game is described. The system includes an electronic funds transfer (EFT) terminal, a networkable component including at least one configurable gaming limit, a Casino Management System (CMS), a database, and a financial network. The networkable component is communicatively coupled to the EFT terminal, the CMS, the database, and the financial network. The EFT terminal is associated with a table game. The database includes a plurality of transaction information.

The EFT terminal transmits a fund transfer request to the networkable component, which transmits the fund transfer request to the financial network. The networkable component retrieves transaction information related to the fund transfer request and the at least one configurable gaming limit and determines that the fund transfer request is compliant or non-compliant with the at least one configurable gaming limit. When the networkable component determines that the fund transfer request is compliant with the at least one configurable gaming limit the networkable component transmits transaction information for the compliant fund transfer request to the CMS and a fund transfer request approval message to the EFT terminal.

The method for enabling financial transactions at a table game begins by receiving a patron input corresponding to a fund transfer request at an EFT terminal that corresponds to a table game. Then, the electronic funds transfer terminal transmits the fund transfer request to a networkable component that is communicatively coupled to the EFT terminal. The networkable component retrieves transaction information related to the fund transfer request and at least one configurable gaming limit from a database that is communicatively coupled to the networkable component. The networkable component determines that the fund transfer request is compliant with the at least one configurable gaming limit and transmits transaction information corresponding to the fund transfer request that is compliant with the at least one configurable gaming limit to a Casino Management System (CMS) that is communicatively coupled to the networkable component.

### FIGURES

The present invention will be more fully understood by reference to the following drawings which are presented for illustrative, not limiting, purposes.

FIG. 1 shows a gaming gateway system that includes an embedded controller disposed on a casino table game or casino slot machine.

FIG. 2 shows a second illustrative transactional system.

FIG. 3 shows another illustrative embodiment of the master gateway operating as an aggregator.

FIG. 4 shows another illustrative embodiment of the master gateway coupled to a plurality of payment processors and a plurality of client devices through a network.

FIG. 5 shows another illustrative embodiment of the master gateway operating as a financial transaction preprocessor and aggregator.

FIG. 6 shows a flowchart of a controller monitoring the data connections with a printer, EFT terminal, server and banking gateway.

FIG. 7 shows an illustrative flowchart of the various operations performed by a master gateway that includes a gaming gateway.

FIG. 8 shows another illustrative flowchart of the various operations performed by a master gateway.

FIGS. 9A-D show a flowchart of steps for processing a transaction using the transactional system.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the systems and methods described herein may vary as to configuration and as to details. The following detailed description of the illustrative embodiments includes reference to the accompanying drawings, which form a part of this application. The drawings show, by way of illustration, specific embodiments in which the invention may be practiced. It is to be understood that other embodiments may be utilized and structural changes may be made without departing from the scope of the claims.

In one embodiment, the transactional system and method permits a gaming patron to initiate and complete a transaction and receive indicia of value such as casino chips at the casino table game. More specifically, the illustrative transactional system and method dispenses an indicia of value to an attendant of the establishment, such as the dealer or croupier at a gaming table. The indicia of value may be a printed record that is used to provide casino chips that may be used by the player at the casino table game. The transactional system and method presented herein operates without having to first receive cash from a conventional EFT process and subsequently convert the cash into casino gaming chips.

In another embodiment, the transactional system and method permits a gaming patron to initiate and complete a transaction and receive an indicia of value such as a casino voucher or electronic gaming credits at an electronic gaming machine (EGM). The systems and methods presented herein allow a gaming patron to utilize their own payment instrument in a payment device located at an electronic gaming machine. Using Payment Card Industry (PCI) certified technology, the transaction is routed to the banking networks and a Ticket-In-Ticket-Out (TITO) ticket is printed using the printer already located at the game. The patron is then able to insert this ticket into the bill validator and an equivalent number of credits will be placed on the game register. Alternatively, the patron can choose to redeem this ticket for cash at any of the pre-existing redemption outlets.

In some embodiments, the systems and methods described herein use a proprietary financial network to route all transactions occurring at a casino property to a single backend server. The backend server has connections to both the banking and processing networks and to the Casino's Accounting and Management Software Infrastructure, which may also be referred to as the Casino Management System (CMS) and/or the Slot Accounting System (SAS). The CMS and SAS use proprietary protocols and thus cannot be directly accessed by the backend server. In the illustrative embodiments presented herein, a Slot Machine Interface Board (SMIB) is used to format the data into a usable fashion for the CMS and SAS.

The gaming gateway apparatus, systems and methods presented herein may operate at an illustrative casino gaming device, such as a table game or casino slot machine, and allow a gaming patron to use a financial instrument (credit, debit, prepaid, or other method of transferring money) (payment card) at the illustrative casino table game, slot machine, or other such gaming device.

In order to provide a product that allows a gaming patron to use a financial instrument, such as a payment card (credit, debit, prepaid, or other method of transferring money), at a gaming device, a vendor must provide protections for the patron to comply with regulatory bodies and particular casino requirements. Further, the protections must demonstrate that the process is safe and secure, while providing complete accounting, privacy, and verification in order to meet all casino and banking regulatory requirements.

Further, regulatory requirements necessitate configuration of the various vendor provided protections, such as gaming limits and rules by or at each casino property. This capability is provided through a separation of functions between the backend server, which can be operated and controlled at and by each casino property, and one or more gateways that can be remote from all casino properties.

The illustrative gaming gateway apparatus, systems and methods enable a gaming service/system provider to provide protections to the regulatory bodies, to the casinos, and to the patron that the financial transactional process is safe and secure, and meets all laws, regulations and rules of Federal, State and/or Tribal entities.

Also, the gaming gateway apparatus, systems and methods provide complete accounting, privacy, verification and can meet all casino and banking regulatory requirements.

Furthermore, the gaming gateway apparatus, systems and methods presented herein allow payment authorization requests to be routed to the banking (or “payment processor”) network.

Further still, the gaming gateway apparatus, systems and methods presented herein create a record of all transactions at various properties, as opposed to local databases which just contain transactions for the individual property.

Further still, the gaming gateway apparatus, systems and methods provide the ability to categorize each transaction by type (gaming, retail, etc.) and route them by different merchant ID codes, which allows each transaction to be processed under the correct MCC (merchant classification code). In addition, different rule sets may be applied by on transaction type.

Additionally, the gaming gateway apparatus, systems and methods presented herein have the ability to apply logic rules that are the result of banking regulations, legal/judicial regulations, problem gaming limits, regulatory rules, and the like. These logic rules may be functions of transaction details which include but are not limited to amount, transaction frequency, location, property, time of day, type of card or individual.

Further still, the gaming gateway apparatus, systems and methods have the ability to apply business logic rules that result in lower transaction costs. These rules may result in the routing of transactions to different payment processors or may have logic functions that prevent repeated unauthorized transactions.

The systems and methods described herein may therefore satisfy the complex web of transactional, regulatory, and security rules governing requests for funds that take place within casinos. The systems may not operate to circumvent various regulatory rules (e.g., as an ATM machine located within a casino), but may enable rule determination and compliance in real time and at any client device enabled to receive a transaction instrument, such as a credit or debit card.

The systems may thus embody an improvement over existing transaction processing systems, particularly over transaction processing systems configured to process gaming transactions, in that a gateway (e.g., a gaming or master gateway) may enable the aggregation and preprocessing of a variety of transaction and user data, which may satisfy a variety of regulatory and transaction processing requirements at a centralized processing hub. This may, in turn, reduce the complexity of the transaction processing system and improve the processing or preprocessing speed of the system as a whole.

Other advantages include, as described herein, transaction processing at a client device, particularly at the gaming client device within a casino and during game play, real-time protection for individuals associated with a problem gaming status as well as for casinos serving those individuals, transaction fee optimization and real-time payment processor selection, player tracking, and the generation buy-in the gateway.

As described herein, the various features and functions presented above can be performed at various stages of the approval process. The apparatus, systems and methods may be embodied in a gateway database associated with a casino property, in an external gateway, or any combination thereof that performs the functions or features described in this description.

In the illustrative embodiment, the gaming gateway system and method presented herein initiates, processes and completes a gaming point of sale transaction that generates a single or multiple approval (e.g., a dual approval) that guarantees that both banking and gaming regulations are satisfied.

In the illustrative embodiment, the transactional system and method presented herein initiates, processes and completes an electronic funds transaction (EFT) or similar equivalent. The transactional system and method may be used as a substitute for an automated teller machine (ATM), cash kiosk, or other such facility capable of completing the desired transaction. The transactional system and method is relatively small and portable, so the transactional system may be easily relocated, e.g. to a patron's point-of-play, thereby facilitating game play. Additionally, the transactional system and method eliminates the need to restock an unattended ATM machine with cash. Furthermore, the transactional system and method operates with fewer complex mechanical components.

In an illustrative embodiment, the transactional system and method operates at a casino table game. By way of example and not of limitation, the casino table game includes card games such as blackjack (also known as “21”), Poker, Pai Gow, Baccarat, and other such card games. Additional illustrative table games include, but are not limited to, wheel games such as roulette and dice games such as craps, Sic Bo and other such dice games.

In some embodiments, the transactional systems and methods operate at a slot machine, which is also referred to interchangeably as an Electronic Gaming Machine (EGM). In the illustrative embodiment, the transactional client device, system and method does not dispense cash, like a typical Automated Teller Machine (ATM). In another embodiment, the transactional client device, system and method dispenses other indicia of value, e.g. loyalty points, gift cards, validated vouchers, or voucher validation codes.

At least one benefit of the systems and methods presented herein is that only a small number of SMIBs will be required to interface with the CMS and SAS, even though EFT terminals on the casino floor can be substantially higher, e.g. over 1000 client devices.

A further benefit is that the systems and methods presented herein integrate with a variety of existing electronic gaming machine technologies each communicating with the CMS and SAS using separate proprietary protocols. The systems and methods further operate in conjunction with Electronic Gaming Machines and slot machines already mounted and/or in operation on a casino floor.

The term “indicia of value” as used herein includes an electronic record, a printed record and a physical token that has a relative worth, i.e. value, to the end user, e.g. customer or patron, and the business or property, e.g. casino. In other words, an electronic record may operate as an indicia of value. Also, a printed record may also operate as an indicia of value.

The indicia of value has a relative worth to the business or property, e.g. casino, and the end user, e.g. patron, in the transactional system and method for a table game that is presented herein.

An “electronic record operating as an indicia of value” is an electronic record that has relative worth to the end user and the business or property. There are a variety of secure communications that communicate an electronic record operating as an indicia of value in the transactional system and method for a table game.

An illustrative electronic record operating as an indicia of value includes the electronic record received from the wireless device, which securely communicates the electronic record to the controller. The controller then proceeds to transmit the electronic record operating as an indicia of value to the payment gateway, which further communicates the electronic record to the financial network or payment processor. The controller then receives an authorization response from the payment gateway. The authorization response is another electronic record operating as an indicia of value. The controller proceeds to transmit the authorization response to the wireless device. Again, the transmitted authorization response is an electronic record operating as an indicia of value.

A “receipt” for the approved transaction is presented at the wireless device. A receipt, i.e. payment record, provides a printed record that a payment was received by the business or property, e.g. casino, from the end user, e.g. patron. However, the receipt is not an electronic record and does not have relative worth. In other words, the receipt is a printed record that does not have an indicia of value.

An “electronic record” (by itself) provides electronic or digital evidence that a business activity or transaction took place at a particular time. The electronic record is captured through an electronic or digital process. An electronic record includes a records management solution, which controls the creation, distribution, use, maintenance and disposition of recorded information that is maintained as evidence of business activities or business transactions. Thus, an electronic record operating as an indicia of value is a subset of an electronic record. An electronic record may include other database attributes that are not specific to the electronic record operating as an indicia of value such as player loyalty information or accumulated loyalty points or player preferences and other such electronic records that are do not correspond to an indicia of value.

A “printed record operating as an indicia of value” is a printed record that has relative worth to the end user and the business or property utilizing the transactional system and method presented herein.

In general, a “voucher” is a printed document that has an indicia of value, which may be exchanged for goods, services, casino chips or any other indicia of value.

A “coupon” entitles the holder of the coupon to a discount for a particular product. A coupon is a type of voucher.

In gaming, the definition of a voucher is more granular because there are a variety of different vouchers including a complete voucher, a duplicate voucher, an incomplete voucher and replacement voucher. A “complete voucher” (in gaming) contains, at a minimum, a complete validation number and is of a quality that can be redeemed through the use of an automated reader or scanner. A “duplicate voucher” is any reprinted complete voucher or incomplete voucher. An “incomplete voucher” contains, at a minimum, the voucher validation number printed across the printed leading edge and is manually redeemable, but is not of a quality that can be redeemed through the use of an automated reader or scanner. A “replacement voucher” is printed following a failed attempt to print a complete or incomplete voucher.

A printed record operating as an indicia of value is different from a complete voucher, a duplicate voucher, an incomplete voucher and replacement voucher; however, the printed record operating as an indicia of value is a type of voucher.

The printed record operating as an indicia of value may contain alphanumeric text, symbols, holographic images, lenticular imagery, codes, images, fully or partially punched holes or other voids, intentional edge irregularity, Braille inscription, other intentional surface irregularities, promotional material, advertising material, other material or information depiction, or any combination thereof.

In the illustrative embodiment, the printed record operating as an indicia of value includes a ticket compatible in size and data format with the ubiquitous ticket-in, ticket-out (“TITO”) standard widely utilized in casino gaming systems. In another embodiment, the printed record operating as an indicia of value is compatible with re-writable data cards known in the casino gaming industry. In yet another embodiment, the printed record operating as an indicia of value includes an article printed on paper or any other substrate media of desired composition and in any desired dimension or format as may be required to accommodate the establishment's preferred method of redemption.

The printed record voucher operates as an indicia of value because it provides a printed record of an “electronic buy in” transaction that can be tracked by the business or property. In the illustrative table game embodiment, the printed record voucher is printed by the illustrative printer when an “electronic buy in” transaction is completed; the dealer accesses the printed record voucher operating as an indicia of value and places the printed record voucher in the table game's cash chute.

The printed record voucher operating as an indicia of value is not a cash equivalent. The printed record voucher operating as an indicia of value may not be redeemed through the use of an automated reader or scanner. Additionally, the printed record voucher operating as an indicia of value may not be manually redeemable.

In the illustrative embodiment, a receipt is generated by the wireless printer. The wireless printer receipt is presented to the end user, e.g. customer or patron. The customer (not the property) is responsible for the receipt. The printed record voucher operating as an indicia of value is distinguishable from the customer receipt because the printed record voucher provides a record of the transaction initiated by the end user, in which the end user received casino chips (i.e. a physical token operating as an indicia of value) or gaming credits (i.e. an intangible token operating as an indicia of value) after providing the appropriate “card” information, e.g. PIN.

An illustrative voucher system includes, but is not limited to, a Ticket-In-Ticket-Out (TITO) system. A TITO ticket is an illustrative complete voucher that can be redeemed through the use of automated reader or scanner. The illustrative voucher may be a PlayOn℠ voucher.

A “physical token operating as an indicia of value” is a physical token that has relative worth to the end user and the business or property. By way of example and not of limitation, casino chips, poker chips and gift cards are illustrative physical tokens operating as an indicia of value.

A “payment gateway” is also referred to interchangeably as the “banking gateway.” The payment gateway is configured to communicate with at least one financial network or payment processor. Additionally, the payment gateway is configured to receive an authorization request, which is associated with an approved transaction.

A “gaming gateway” is configured to manage and perform the regulatory requirements associated with gaming or gambling. By way of example and not of limitation, the gaming gateway may include problem gaming limits/rule sets. Illustrative problem gaming rule sets may include daily limits or may pause the period during which a person may withdraw funds to allow for a “cool down” period. Additionally, the gaming gateway may be configured to communicate with a regulatory gateway that includes a variety of rule sets such as tribal rules, state gambling rules, federal gaming rules, casino property gaming rules and other such gaming or “gambling” rule sets. Gaming is used to refer to gambling.

The gaming rules and gaming limits may include a variety of factors used by the gateway to determine the applicability of a particular gaming limit or gaming rule. The gateway can apply one or more of the factors when determining the applicability of a particular gaming rule or gaming limit to a fund transfer request or transaction. These factors can include, but are not limited to, temporal factors, geographic factors, and identification factors. In operation, each gaming limit and gaming rule provides a restriction on the number of transactions or total value of transactions during a time period, within a particular location, and attributed to a particular identity. The various factors would then be used by the gateway to define the time period, such as a day, as a calendar day, a gaming day, or a trailing period of 24 hours. Further, the gateway can use the factors to define a particular location as within a 50 mile radius, within the boundary of a particular State, within the limits of a City, within a Zip Code, within one or more properties of a Gaming Entity, within a single casino property, on a certain floor of a casino, at a particular bank of gaming machines, at a particular gaming machine, at a particular table, or at a particular position of a particular table. Finally, the gateway can use the factors to define an identity to which a gaming rule or gaming limit applies, such as a particular patron or a particular debit instrument (i.e. per card).

For purposes of this patent, reference is also made to a master gateway, which includes the payment gateway and the gaming gateway.

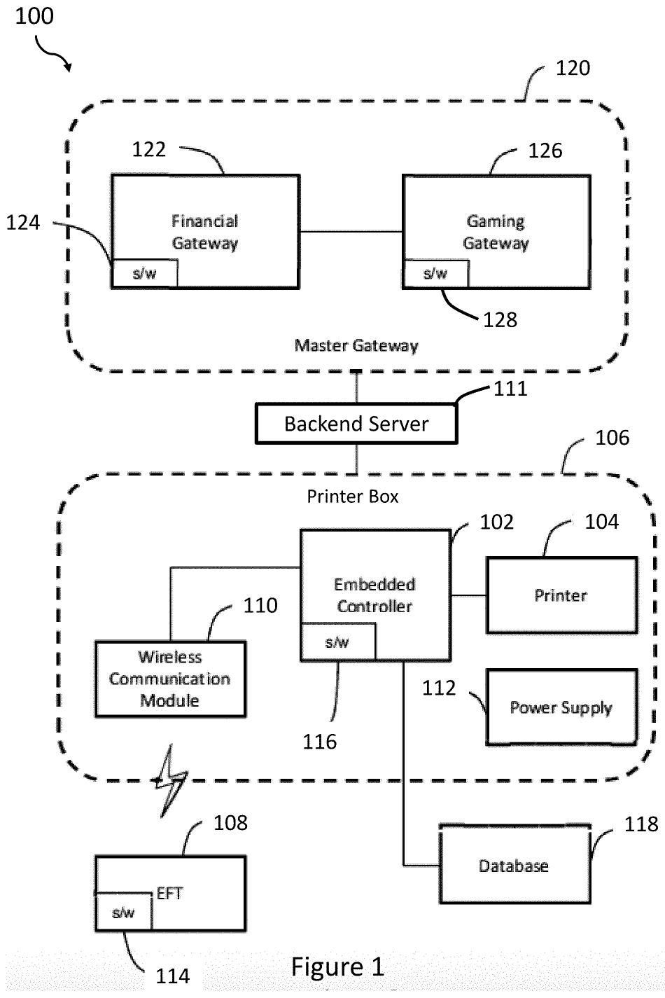

Referring to FIG. 1 there is shown an illustrative gaming gateway system 200 that includes an embedded controller disposed at a casino table game or casino slot machine. The gaming gateway system 100 includes a controller 102 that is communicatively coupled to a printer 104. By way of example and not of limitation, a hard wire connection is made between an embedded controller 102 and a dedicated printer 104, which generates a printed record operating as an indicia of value. In the table embodiment, the combination of the embedded controller 102 and printer 104 is enclosed in a printer box or housing 106.

By way of example and not of limitation, the embedded controller 102 may be embodied as an ARM based Linux embedded controller with USB and Ethernet connectivity to the printer 104. The printer 104 may be an Ithaca 950 printer or a Nanoptix NextGen™ that has a hardwire connection to the embedded controller 102. Alternatively, the printer has a secure wireless connection to the embedded controller 102. More specifically, the embedded controller 102 may be communicatively coupled to the printer 104 using a secure wireless communication channel that operates using a wireless communication protocol such as Wi-Fi, Bluetooth, Digimesh, Zigbee, or other such wireless communication protocol.

In the illustrative embodiment, the embedded controller 102 includes a logic component, such as a central processing unit (“CPU” or “processor”), a graphics processor or graphics processing unit (“GPU”), a field programmable gate array (“FPGA”), and the like. The controller 102 further includes at least one static or random access memory, at least one port that permits connection of one or more external memory or data storage devices. For illustrative purposes, the CPU may include an ARM-based microprocessor, RISC microprocessor, or other such microprocessor suitable for the intended purpose.

The illustrative embedded controller 102 comprises one or more local device and network connectivity modules for communication using wired, wireless, near-field communications (NFC), other electromagnetic, fiber optic, other optical, or other communication means and/or protocols, including but not limited to USB (X).(Y), the proprietary Standard Peripheral Communication (“SPC”) protocol used in certain gaming devices, RS-232, RS-422, RS-485, IEEE 1394, wired Ethernet, Wi-Fi, 802.1 (x)(y) compliant methods, Bluetooth™, infrared, optical, radio frequency, CDMA, GSM, GPRS, satellite, and the like. The network communication modules may include one or more ports enabled and associated with the network communication modules. The embedded controller may be configured to provide multiple ports that are simultaneously active using different protocols, multiple instances of the same protocol, or any combination thereof.

The embedded controller 102 and printer 104 communicate via a local communication protocol such as, but not limited to, RS-232, USB(X).(Y), SPC, RS-422, RS-485, IEEE 1394, or the like. By way of example and not of limitation, a protocol conversion interface or controller board may be utilized between the embedded controller 102 and the dedicated printer 104 to establish a secure data communication path between the two devices utilizing available or desired ports in each one. The dedicated printer 104 includes any device suitable for generating a printed record operating as an indicia of value.

The illustrative embedded controller 102 operates under the control of an operating system such as, but not limited to, one based on the open-source Linux kernel with appropriate device drivers and other software necessary to securely implement transactional functionality presented herein. More generally, the embedded controller 102 may operate with any other suitable operating system based on opensource or proprietary software or firmware.

In one embodiment, the printer box 106 is disposed below a table game. The illustrative printer box 106 provides a single semiportable enclosure. In the table game embodiments, the housing 106 is integrated into the table game so that a surface of the housing is visible to the dealer or casino personnel, for example the visible housing surface may be exposed to the dealer on a side portion of the table game in the dealer's area that is not visible to patrons. However, the housing 106 may be integrated into a table game so that the housing 106 is also visible to patrons at the table game, i.e. on the top surface of the table game or the gaming surface of the game. In these embodiments, a display is disposed on the visible surface of the housing 106. The display is communicatively coupled to the embedded controller 102 in order to receive transaction data relating to transaction requests and transmit dealer confirmations relating to authorized transactions.

The printer box 106 may be quickly and easily relocated within an establishment as desired. A gaming property, such as a casino, may deploy such printer boxes 106 in locations where there is a demand for the transactional system and methods presented herein. Since the printer boxes 106 are semi-portable systems, the printer boxes 106 may be moved around to any location that has suitable AC power.

The embedded controller 102 and the dedicated printer 104 operate directly from conventional 120V AC power. One or more transformers, power supplies, power converters, or any suitable combination thereof are supplied and configured between the devices and the source of 120V AC power to provide power to the two devices with the required voltage and current availability for proper operation. Such combination of transformers, power supplies, and power converters may provide regulated or unregulated power to the devices. An illustrative power supply 112 includes a 24V power supply unit that powers the printer 104. Additionally, the power supply 112 includes a 25V to 5V voltage converter that powers the embedded controller 102, which in turn powers the wireless communication module 110.

The embedded controller 102, the dedicated printer 104, or the combination thereof operate for a limited time utilizing a source of stored energy, such as an uninterruptable power supply (“UPS”), other battery configuration, charged capacitive storage device, or the like. Such stored energy devices charge automatically from an 120V AC power source when such power is available, but in the event of any interruption in such source, either or both device(s) continue to operate for a limited period of time using the stored energy. This is particularly advantageous to permit completion of any EFT in process at the time of an interruption in the commercial power service or if the subsystem should become inadvertently disconnected from AC power.

In the illustrative embodiment, the embedded controller 102 has a limited number of secure connections to other devices, thus a firewall is not required between the embedded controller 102 and the securely connected devices. Also, the illustrative embedded controller 102 constantly monitors and automatically detects any disconnection(s) and attempted reconnection(s). If any of the data connections are disconnected or otherwise inoperative, no transactions may be processed by the transactional system and method. For example, the embedded controller 102 securely communicates with an Electronic Funds Transfer (EFT) terminal 108, a backend server, and a master gateway 120 without the need for a firewall.

Alternatively, at least one firewall may be disposed between the embedded controller and at least one of the data connections including, but not limited to, the EFT terminal 108, or the master gateway 120 and a backend server 111; and the type of firewall is dependent on the type of data connection.

The embedded controller 102 is also communicatively coupled to a wireless device. In the illustrative embodiment, the wireless device is an EFT terminal 108 that uses a wireless connection such as an IEEE 802.11 (WiFi), IEEE 802.15 (Bluetooth/Zigbee) or other such wireless communication standard. The EFT terminal 108 may include a printer for printing a receipt or other indicia of a transaction for the patron. The process of generating a secure communication between the embedded controller 102 and the EFT terminal 108 is performed by an EFT software module 114 communicating with an embedded controller software module 116. In the illustrative embodiment, the EFT software module 114 is configured to present the illustrative end user, e.g. casino patron, with user instructions. As described herein, the embedded controller 102 may be wirelessly coupled to the wireless EFT terminal 108, which is disposed on the top or upper surface of a table game, i.e. the gaming surface. The table EFT terminal 228 components may also be an external attachment or embedded in the table game. The table EFT terminal 228 may be a tethered processing terminal with embedded swipe components fitted to seated game stations in race and sports book, keno and bingo operations, or swipe components embedded into mobile handheld games. EFT terminals may also include remote/mobile/handheld system components or terminals assigned to table games.

More specifically, the illustrative EFT terminal 108 may be a Blue Bamboo P200, which includes a PCI certified receipt printer, a PIN pad, an NFC contactless solution, an LCD display, an EMV card reader and a mag stripe card reader. The EMV card reader is compatible with the EMV global standard for authentication of credit and debit card transactions. The EFT terminal 208 may also include a payment card industry (PCI) and pin entry device (PED) certified device.

The Blue Bamboo P200 or other such compatible device includes proprietary software 114 that may be embodied as a STIPIet that conforms to the Global Platform Small Terminal Interoperability Platform (STIP) standard. The pre-encrypted data sent between the STIPIet or comparable application running on the EFT terminal 108 and the custom proprietary software application 116 running on the embedded controller may be encoded using a proprietary format. Even if the encryption of the data is broken, the plaintext format of the data will still be unknown. Alternative devices are configured to provide similar functionality as the STIPlet with a combination of firmware and software that operates on a device configured to perform the functions presented herein.

Further, the EFT terminal 108 may be a YouTransactor SK100 which includes a PCI certified PIN pad, an NFC contactless solution, an LCD display, an EMV card reader and a mag stripe card reader. The EMV card reader is compatible with the EMV global standard for authentication of credit and debit card transactions. The EFT terminal 108 may also include a payment card industry (PCI) and pin entry device (PED) certified device.

The YouTransactor SK100 or other such compatible device includes proprietary software 114. The pre-encrypted data sent by the custom software application or comparable application running on the EFT terminal 108 and one or more of the wireless communication module 110 may be encoded using a proprietary format. Even if the encryption of the data is broken, the plaintext format of the data will still be unknown. Alternative devices are configured to provide similar functionality as the custom software application with a combination of firmware and software that operates on a device configured to perform the functions presented herein.

The wireless device, EFT terminal 108, includes a hardware module (not shown) that supports secure wireless communication using wireless communication protocols such as Bluetooth, Digimesh, Zigbee, Wi-Fi and other such wireless communication protocols. Additionally, the embedded controller 102 is communicatively coupled to a wireless communication module 110, which is also configured to support secure wireless communication using wireless communication protocols such as Bluetooth, Digimesh, Zigbee, WiFi and other such wireless communication protocols.

More generally, the wireless EFT terminal 108 may comprise a central processing unit (“CPU”), one or more static or random access memories, and one or more ports to permit connection of one or more external memory or data storage devices. The wireless device may further include a point-of-sale (POS) personal identification number (PIN) entry keypad and one or more displays or display devices. The wireless device may include a payment card reader that may be a smart card reader, a magnetic card reader, a high-capacity optical storage media reader, a bar code, QR code, or other optical data storage reader, a punch card reader, a Braille reader, a contactless card reader, a proximity mobile payments reader that enables communication with smart phone devices, a contactless proximity card reader that processes secure smart ticketing and electronic payments using contactless secure mobile commerce technology, or any other device or system which retrieves information stored on or in a payment card or its functional equivalent. The wireless device may include one or more network connectivity modules for communication using wired, wireless, near-field communications (NFC), other electromagnetic, fiber optic, other optical, or other communication means and/or protocols, including but not limited to Wi-Fi, 802.1 (x)(y) compliant methods, Bluetooth™, infrared, optical, radio frequency, CDMA, GSM, GPRS, and satellite. The network communication modules may include one or more ports enabled and associated with the network communication modules. Network connectivity may be achieved by the wireless device 108 via any one or combination of several communication modules and communication modes based on operational situations.

For example, the wireless EFT device 108 may communicate via a wired network using the appropriate wired communication module while the wireless device is placed in a wired connectivity cradle equipped with access to a wired network and the appropriate connector(s) to operatively communicate with a wired communication module port. When the wireless EFT device 108 is removed from the wired connectivity cradle, the wireless EFT device 108 may be switched from a wired communication mode to a wireless communication mode via activation and deactivation of the appropriate communication modules.

The switch from wired to wireless communication mode may be performed automatically by software or firmware running on the wireless device or performed manually at the direction of a user. Similarly, the wireless EFT device 108 may automatically select or be manually instructed to utilize one of several available communication modules and modes to use based on operational factors such as, but not limited to, availability of service, signal strength, security considerations, available bandwidth, link reliability, and the like by activating desired communication module(s) and deactivating others.

The wired connectivity cradle may also comprise a wireless access port operatively connected to the wired network and accessible by a wireless communication module in one or more wireless devices, thereby providing a localized point of network access for one or more wireless devices in a gaming environment within which the electromagnetic spectrum may be highly congested and radio frequency interference is prevalent. The wireless device 108 may comprise a printer and/or a printer port for connection of an external printer or a plurality of printers connected to a plurality of gaming devices via wired, wireless, or other communication means.

The wireless EFT device 108 may be powered by alternating current, direct current, battery, stored charge, solar or any other known power source available at the point of use. Wireless devices powered by stored energy sources may be periodically recharged from other power sources, including but not limited to charging a stored energy source when the wireless device 108 is placed in a special cradle that may provide wired network connectivity as described above in addition to power charging capability. The illustrative EFT terminal 108 is a handheld wireless device that is powered by a rechargeable battery. For the purposes of this disclosure, the terms EFT terminal, wireless device, wireless EFT device, and Point of Sale (POS) terminal are used interchangeably.

In the illustrative embodiment, the embedded controller 102 does not perform payment functions; rather, the payment functions are initiated by the EFT terminal 108. The embedded controller 102 securely transmits the requests from the EFT terminal 108. Since the embedded controller does not perform the payment function of generating the EFT request, there is little or no risk of a security breach resulting from the embedded controller 102 initiating a payment transaction. Thus, the wireless EFT device 108 securely communicates a plurality of transactional data to the controller 102, wherein the transactional data corresponds to the transaction initiated by the wireless EFT device 108.

The embedded controller 102 is communicatively coupled to a database 118. By way of example and not of limitations, the illustrative database 118 is a mySQL relational database that is communicatively coupled to a web server. Authorized users may access the SOL database resident on the database server via HTTPS or other secure connection using conventional computing hardware via the web server.

The embedded controller 102 is also communicatively coupled to a “master gateway” 120 through a backend server 111. The backend server 111 is a computer that provides data to other computers. The backend server 111 may serve data to systems on a local area network (LAN) or a wide area network (WAN) over the Internet. Many types of servers exist, including web servers, mail servers, and file servers. Each server is configured to run software specific to the purpose of the server. While server software is specific to the type of server, the hardware is not as important. In fact, a regular desktop computers can be turned into a server by adding the appropriate software. For example, a computer connected to a home network can be designated as a file server, print server, or both. In some embodiments, a table controller is communicatively coupled to the backend server through a hard wire connection. A backend server 111 is unique to each licensee or casino, and thus the master gateway 120 may be communicatively coupled to several backend servers 111, each associated with a different licensee casino.

In this embodiment, the backend server is the conduit through which table game, slot machines, and EGMs are communicatively coupled to the master gateway 120, a casino management system (CMS), and/or a slot accounting system (SAS).

The master gateway 120 may include a financial gateway 122 and corresponding software module 124. Additionally, the master gateway 120 also includes a gaming gateway module 126 that includes a related software module 128. The financial gateway 122 may be referred to as a “payment gateway,” or a “banking gateway.” For purposes of this patent, the terms “financial gateway,” “payment gateway,” and “banking gateway” are used interchangeably, however, in general the term “banking gateway” refers to the illustrative casino table embodiment and “payment gateway” or “financial gateway” refer to the more general embodiment. The payment gateway is configured to communicate with at least one financial network. Additionally, the payment gateway is configured to receive an authorization request, which is associated with an approved transaction.

By way of example and not of limitation, the embedded controller 102 is communicatively coupled to the master gateway 120 through the backend server 111 using a wired Ethernet (TCP/IP) that employs an illustrative security protocol such as HTTPS utilizing SSL/TLS. Other security protocols may also be used. The HTTPS protocol provides authentication and protects the privacy and integrity of the exchanged data.

The financial gateway software module 124, resides in the financial gateway 122 and includes proprietary software that communicates with the embedded controller 102. In the illustrative embodiment, the embedded controller 102 is communicatively coupled to a financial gateway API using a secure network communication protocol. The financial gateway 122 is communicatively coupled to one or more financial networks, including but not limited to the PLUS, STAR, CIRRUS, INTERLINK, MONEY PASS, or NYCE networks, that provide access to the server(s) associated with patrons' financial accounts.

In the illustrative embodiment, the financial gateway software module 124, which resides in the financial gateway 122, includes proprietary software controlled by the financial gateway 122. More specifically, the banking gateway software module 124 includes a financial gateway API that is proprietary to at least one specific payment gateway service. In an alternative embodiment, the banking gateway does not include a banking gateway software module; thus, the banking gateway represents an external service associated with, but not controlled by, the transactional system.

In operation, the embedded controller 102 connects to and exchanges data with the external financial gateway 122 via the backend server 111. A transaction is initiated with an outbound EFT request, which is associated with a patron interacting with the EFT terminal 108. Applicable data is forwarded from the EFT terminal 108 to the embedded controller 102, which is then sent to the backend server 111, from the backend server 111 on to the financial gateway 122 and then to the appropriate financial network associated with the institution or other entity that manages and controls the patron's account. The result of the processed EFT request from the institution or entity is conveyed back to the financial gateway 122 via the financial network, from the financial gateway 122 to the backend server 111, and then back to the embedded controller 102 for further disposition.

More generally, the financial gateway 122 is communicatively coupled to the controller 102. The financial gateway 122 securely communicates with at least one financial network. The controller 102 securely communicates the received transactional data to the financial gateway 122 through a respective backend server 111. The controller 102 then receives an authorization response from the financial gateway 122 for an approved transaction via the backend server 111. The controller 102 communicates the authorization response to the wireless EFT device 108, which presents a receipt for the approved transaction at the wireless EFT device 108. The controller 102 may communicate the authorization response to the printer 104, which generates a printed record operating as an indicia of value that corresponds to the transaction initiated by the wireless EFT device 108. In the table game embodiment, the printed record operating as an indicia of value is converted to at least one casino chip at the table game. In a slot machine or electronic gaming machine (EGM) embodiment, only a receipt is printed to serve as an indicia of value for the patron, while the slot machine or EGM receives a voucher validation code or the equivalent thereof from the CMS or SAS to verify gaming credits presented to the patron on the slot machine or EGM. As an alternative to, or in conjunction with printing an indicia of value at the printer 104, the controller 102 may communicate the authorization response to a table-mounted display. The display may then prompt a dealer or other casino employee to confirm the authorization prior to dispensing gaming chips or other indicia of value to the patron requesting the EFT.

In yet another embodiment, the payment/banking gateway also acts as a gaming regulatory gateway and adheres to limits, rules and standards that are set forth in accordance with specific gaming jurisdictions. The gateway may or may not handle rules and limits for more than one jurisdiction or geographical area simultaneously, such as handling rules of jurisdiction 1 for Casino A located in site A and rules of jurisdiction 2 for Casino B located in site B. The gateway makes initial determinations based on these limits, rules and standards as to whether a transaction should be processed and sent on to the financial network or rejected without being sent.

The initial determinations made by the master gateway or payment/banking gateway are facilitated by a database containing a plurality of gaming limits and gaming rules that each include a variety of factors used to determine the applicability of a particular gaming limit or gaming rule to a fund transfer request. This database may be included in or communicatively coupled to the master gateway 120. These factors stored in the database upon which the master gateway makes an initial determination can include, but are not limited to, temporal factors, geographic factors, and identification factors. Each gaming limit and gaming rule provides a restriction on the number of transactions or total value of transactions during a time period, within a particular location, and attributed to a particular identity. The temporal factors provide granularity to the gaming limit or gaming rule time period, defining the time period of an hour as a trailing period of 60 minutes or 2:00 p.m. to 3:00 p.m., e.g., and defining the time period of a day as a calendar day, a gaming day, or a trailing period of 24 hours. The geographic factors provide granularity to the gaming limit or gaming rule location restriction such as by defining a location as any transactions occurring within a 50 mile radius, within the boundary of a particular State, within the limits of a City, within a Zip Code, within one or more properties of a Gaming Entity, within a single casino property, on a certain floor of a casino, at a particular bank of gaming machines, at a particular gaming machine, at a particular table, or at a particular position of a particular table. Further, the geographic factors may define a casino property as a particular casino location or any casino owned by a certain Gaming Entity, i.e. a particular legal entity such as a corporation. The identification factors provide granularity to the gaming limit or gaming rule identity restriction such as by defining that the gaming rule or gaming limit applies to a particular patron or a particular debit instrument (i.e. per card).

The gaming limits include problem gaming limits, property limits, daily limits, and customer limits. Each of these transaction limits may be configured by a licensee, i.e. a particular casino or group of commonly owned casinos, while the customer limit may be configured by each customer/patron. Additionally, an administrator of the master gateway 120 may access and configure each limit. While administrators will have access directly to the master gateway, licensees will have access to the master gateway 120 and the various limits through a backend server 111 and/or casino network, and individual patrons will interact with a casino network or backend server 111 to configure one or more gaming limit. Initially each limit will be set at a maximum value, restricting both licensees and patrons to the option of reducing a particular limit instead of increasing that limit. For example, a problem gaming limit may initially be set to a regulatory maximum of $1,000/day/payment card/casino. A first licensee may elect to set a house limit at $1,000/day/patron/casino. Thus, the first licensee's house limit would prevent patrons from legally circumventing the regulatory maximum limit by switching from a first payment card to a second payment card, which would allow them to access $2,000 one day in a single casino by splitting the withdrawals among their two cards. In contrast, a second licensee may establish its own house limit of $800/day/payment card/casino, which is less than the regulatory maximum, but would allow a single patron $800 in one day from each of their payment cards. This would provide a patron at the second licensee's casino access to $800 times the number of payment cards that patron can withdraw $800 with on a single day. In these examples, a patron may elect to further reduce their personal daily limit at the first licensee's casino to $800/day and a second personal daily limit at the second licensee's casino to $800/day. This patron would no longer be able to withdraw the house limit of $1,000/day in the first licensee's casino, and would no longer be able to withdraw $800/day from each of multiple payment cards in the second licensee's casino.

In one embodiment, the master gateway 120 retrieves gaming limits and gaming rules applicable to a fund transfer request, such as by assessing the transaction information associated with the fund transfer request for the location from which the fund transfer request was made by a patron and determining that one or more tribal gaming rules, one or more state gaming rules, one or more federal gaming rules, or any combination thereof applies to the fund transfer request. The master gateway 120 can also assess the transaction information associated with the fund transfer request for the identity of the patron making the request or the particular card associated with the request and determining that one or more gaming limit, such as a problem gaming limit, a House gaming limit, or a combination thereof applies to the fund transfer request.

The master gateway 120 further retrieves transaction information for all other transactions related to the fund transfer request based upon the factors defining the applicable gaming limits and gaming rules, i.e. other transactions made by the same patron, with the same payment card, or by the same patron within a certain time period. The master gateway 120 can then make a determination (initial or otherwise) of whether the fund transfer request is compliant or non-compliant with the applicable gaming limits and/or gaming rules.

The financial gateway 122 also has the ability to apply business based logic rules to initiated transactions. These parameters will determine the optimal transaction routing through the payment networks, such as by minimizing fees, and can also determine whether or not to deny transactions based on pre-determined criteria, such as various limits.

In operation, the embedded controller 102 connects to and exchanges data with the backend server 111 and the financial gateway 122. The transaction is initiated with an outbound EFT request, which is associated with a patron interacting with the wireless EFT terminal 108. Applicable data is forwarded from the wireless EFT terminal 108 to the embedded controller 102, which is then sent to the backend server 111, the financial gateway 122, and then to the appropriate financial network associated with the institution or other entity that manages and controls the patron's account. The result of the processed EFT request from the institution or entity is conveyed back to the financial gateway 122 via the financial network, from there to the backend server 111, and then back to the embedded controller 102 for further disposition. The financial gateway 122 also has the ability to apply business based logic rules to initiated transactions. These parameters will determine the optimal transaction routing through the payment networks and can also determine whether or not to deny transactions based on pre-determined criteria constituting the applicable gaming rules and limits.

The transactional system 100 permits end users, e.g. casino patrons, to draw funds electronically from a financial account which they own or are authorized to access, provided that the account has been enabled to permit such transactions. Typically, customers of financial institutions include but are not limited to banks, savings and loans associations, credit unions, and the like may obtain a debit card linked to one or more of their financial account(s) with said institution that are linked to the Visa or MasterCard authorization network, and provide direct debit capability from the account(s). Financial institutions and a multitude of other entities also issue credit cards to their customers, including but not limited to MasterCard, Visa, Discover, American Express, and the like, that are linked to a credit account in the name of the customer. Subject to the specific limitations of each such account, customers may draw funds on the account. Similarly, patrons may own one or more financial accounts managed or administered by a non-financial institution third party service. Such non-financial institution third party services may include, but are not limited to, PayPal, Amazon Payments, Google Wallet, WePay, Skrill, ProPay, and the like. All of the accounts and services named above, and any similar thereto, are envisioned and may be utilized therewith. The transactional systems and methods presented herein may transfer funds from any account which permits such transfer via an electronic system or method provided that the patron has properly and independently established such ability in accordance with the requirements of the account administrator(s) in advance.

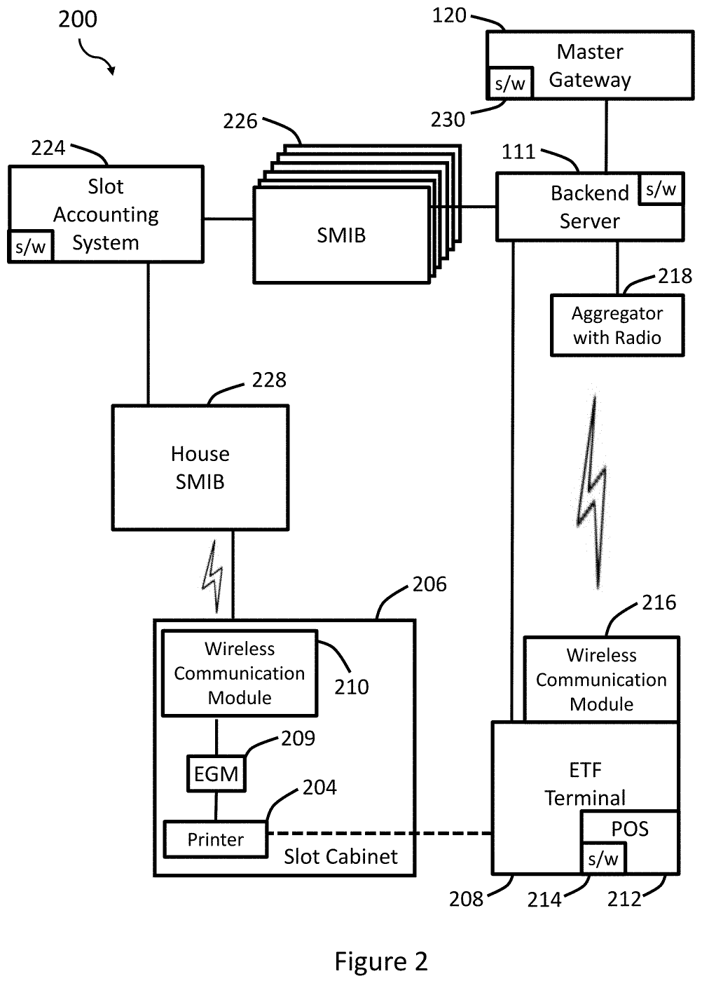

Referring to FIG. 2 there is shown a second illustrative transactional system 200. The transactional system 200 includes an EFT terminal 208 that is communicatively coupled to a printer 204 housed in a slot cabinet 206 with an electronic gaming machine (EGM) 209 and a wireless communication module 210. The EFT terminal 208 can further include a Point-of-Sale (POS) terminal 212. The POS functions can be performed by a software module 214 residing in the POS terminal 212 or the EFT terminal 208. The EFT terminal 208 can further include or be communicatively coupled to a wireless communication module 216. In some embodiments, the wireless communication module to which the EFT terminal 208 is communicatively coupled is the wireless communication module 210 housed in the slot cabinet 206, while in other embodiments the EFT terminal 208 has its own wireless communication module 216 that is separate and distinct from the wireless communication module 210 housed in the slot cabinet 206. The EGM 209 may include an integrated slot controller or be communicatively coupled to a stand-alone controller housed in the slot cabinet 206.

The slot controller is communicatively coupled to the wireless communication module 210 and a printer sharing board which is communicatively coupled to the printer 204. The slot controller is configured to receive encrypted data from an associated POS 212 and communicate the encrypted data to the wireless communication module 210. The wireless communication module 210 communicates incoming data transmissions containing authorization and voucher validation information. The wireless communication module 210 may also be configured to provide broadcast and point-to-point transmissions, and forwards packets not intended for the slot controller, but which are intended for multi-hop transmissions to other slot controllers (not shown). These point-to-point transmission can be broadcasts of encrypted data directly or via a wireless mesh network to the aggregator 218. Thus, the wireless communication modules may be configured to provide the broadcast and/or point-to-point transmissions in order to forward packets not intended for the EFT terminal 208 associated with the particular wireless communication module 210 receiving the transmission/broadcast, but which are intended for multi-hop transmissions to other controllers.

Both the wireless communications modules 210 and 216 are configured to receive encrypted data from an EFT terminal 208 (i.e., a client device) and broadcast or communicate the encrypted data directly or via a wireless mesh network to an aggregator 218. The illustrative wireless communications modules 210 and 216 use IEEE 802.15 wireless communication protocols to send data to the aggregator 218 located at various points inside of the casino. As described in further detail below, the wireless communications modules 210 and 216 also communicate incoming data transmissions containing authorization and voucher validation information. The wireless communication modules 210 and 216 may also be configured to provide broadcast and point-to-point transmissions, and forward packets not intended for EFT terminal 208, but which are intended for multi-hop transmissions to other embedded controllers (not shown).

The wireless communications modules enable communications with at least one other wireless communication module over short distances using point-to-point or broadcast packets that allow for bi-directional data transmission between each POS device located on a casino gaming floor. The wireless communication module allows each EFT device 208 to send and receive data through radio transmissions sent from an out of range EFT device 208 through a series of data rebroadcasts from at least one wireless communications module that is communicatively coupled to each out of range EFT device 208.

The printer 204 includes any device suitable for generating a printed record operating as an indicia of value. The illustrative EFT terminal 208 includes custom software 214 that allows a patron to enter transaction details such as amount and provide fee approval. Additionally, the illustrative EFT terminal 208 can support receiving a magstripe card swipe, an EMV card with a smart card and other such cards or NFC type device.

The EFT terminal 208 also encrypts the transaction details for transmission to a networkable component that is communicatively coupled to a financial network. In the illustrative embodiment, the networkable component may be embodied as a master gateway 120, a backend server 111 or a combination thereof.

The master gateway 120 may be a hardware device that acts as a “gate” between two networks, which may be a router, firewall, server, or other device that enables traffic to flow in and out of the network. While a gateway protects the nodes within the network, it is also a node. The master gateway node may be on the edge of the network so that all data must flow through the master gateway before coming in or going out of the network. The master gateway may also translate data received from outside networks into a format or protocol recognized by devices within the internal network.

The master gateway 120 may also be embodied as a router in an illustrative small network. A router allows computers within the local network to send and receive data over the Internet. A firewall is another type of gateway that filters inbound and outbound traffic, disallowing incoming data from suspicious or unauthorized sources. A proxy server is another type of gateway that uses a combination of hardware and software to filter traffic between two networks. For example, a proxy server may only allow local computers to access a list of authorized websites.

The illustrative backend server 111 is a computer that provides data to other computers. The backend server 111 may serve data to systems on a local area network (LAN) or a wide area network (WAN) over the Internet. Many types of servers exist, including web servers, mail servers, and file servers. Each server is configured to run software specific to the purpose of the server. While server software is specific to the type of server, the hardware is not as important. In fact, a regular desktop computers can be turned into a server by adding the appropriate software. For example, a computer connected to a home network can be designated as a file server, print server, or both.

The EFT terminal 208 is configured to also display authorization or decline information after it is received from the master gateway 120. In the illustrative embodiment, the EFT terminal 208 is injected with a set of keys specific to the banking processor at a third-party injection site, which allows the user's financial data to be tokenized upon entry and only decoded by the processor.

The process of generating a secure communication between one or more of the wireless communication modules 210 and 216 and the EFT terminal 208 is performed by a software module 214 resident in the EFT terminal 208. In the illustrative embodiment, the EFT or POS software module 214 is configured to present the illustrative end user, e.g. casino patron, with user instructions.

In an illustrative embodiment, the EFT terminal 208 is a YouTransactor SK100 which includes a PCI certified PIN pad, an NFC contactless solution, an LCD display, an EMV card reader and a mag stripe card reader. The EMV card reader is compatible with the EMV global standard for authentication of credit and debit card transactions. The POS terminal 212 may also include a payment card industry (PCI) and pin entry device (PED) certified device.

The YouTransactor SK100 or other such compatible device includes proprietary software 214. The pre-encrypted data sent by the custom software application or comparable application running on the EFT terminal 208 and one or more of the wireless communication modules 210 and 216 may be encoded using a proprietary format. Even if the encryption of the data is broken, the plaintext format of the data will still be unknown. Alternative devices are configured to provide similar functionality as the custom software application with a combination of firmware and software that operates on a device configured to perform the functions presented herein.

More generally, the EFT terminal 208 or client device may comprise a central processing unit (“CPU”), one or more static or random access memories, and one or more ports to permit connection of one or more external memory or data storage devices. The device may further include a point-of-sale (POS) personal identification number (PIN) entry keypad and one or more displays or display devices. The device may include a payment card reader that may be a smart card reader, a magnetic card reader, a high-capacity optical storage media reader, a bar code, QR code, or other optical data storage reader, a punch card reader, a Braille reader, a contactless card reader, a proximity mobile payments reader that enables communication with smart phone devices, a contactless proximity card reader that processes secure smart ticketing and electronic payments using contactless secure mobile commerce technology, or any other device or system which retrieves information stored on or in a payment card or its functional equivalent. The device may include one or more network connectivity modules for communication using wired, wireless, near-field communications (NFC), other electromagnetic, fiber optic, other optical, or other communication means and/or protocols, including but not limited to Wi-Fi, 802.1 (x)(y) compliant methods, Bluetooth™, infrared, optical, radio frequency, CDMA, GSM, GPRS, and satellite. The network communication modules may include one or more ports enabled and associated with the network communication modules. Network connectivity may be achieved by the device via any one or combination of several communication modules and communication modes based on operational situations. For example, the EFT device may be a handheld mobile device that communicates via a wired network using the appropriate wired communication module while the handheld mobile device is placed in a wired connectivity cradle equipped with access to a wired network and the appropriate connector(s) to operatively communicate with a wired communication module port. When the handheld mobile device is removed from the wired connectivity cradle, the handheld mobile device may be switched from a wired communication mode to a wireless communication mode via activation and deactivation of the appropriate communication modules. The switch from wired to wireless communication mode may be performed automatically by software or firmware running on the wireless handheld device or performed manually at the direction of a user. Similarly, the wireless device may automatically select or be manually instructed to utilize one of several available communication modules and modes to use based on operational factors such as, but not limited to, availability of service, signal strength, security considerations, available bandwidth, link reliability, and the like by activating desired communication module(s) and deactivating others. The wired connectivity cradle may also comprise a wireless access port operatively connected to the wired network and accessible by a wireless communication module in one or more wireless devices, thereby providing a localized point of network access for one or more wireless devices in a gaming environment within which the electromagnetic spectrum may be highly congested and radio frequency interference is prevalent. The wireless handheld device may comprise an onboard printer and/or a printer port for connection of an external printer or a plurality of printers connected to a plurality of gaming devices via wired, wireless, or other communication means. The wireless device may be powered by alternating current, direct current, battery, stored charge, solar, or any other known power source available at the point of use. Wireless devices powered by stored energy sources may be periodically recharged from other power sources, including but not limited to charging a stored energy source when the wireless device is placed in a special cradle that may provide wired network connectivity as described above in addition to power charging capability.

Additionally, the wireless communication modules 210 and 216 are also configured to support secure wireless communication using wireless communication protocols such as Bluetooth, Zigbee, DigiMesh, WiFi and other such wireless communication protocols. In the illustrative embodiment, the wireless protocol is the 802.15.4 wireless protocol. Other illustrative wireless protocols include GSM/GPRS, CDMA, 802.11 and Bluetooth.

The wireless network is a protocol that uses the 802.15.4 standard and adds additional routing and networking functionality. Most notably, the invention adds mesh networking to the underlying 802.15.4 radio. Mesh networking is used in applications where the range between two points may be beyond the range of the two radios located at those points, but intermediate radios are in place that could forward on any messages to and from the desired radios.

Additionally, the software protocol within the radios will take care of retries, acknowledgements and data message routing. Software also has the ability to self-heal the network. Devices in the network specification can forward all messages not intended for that particular device.

The 802.15.4 network was designed for low power and low bandwidth applications. The software protocol may be used for high density locations such as casino gaming floors and public events. In the illustrative embodiment shown in FIG. 2, the illustrative wireless communication module 216 communicates with an aggregator 218.

The aggregator 218 receives the wireless transmissions from the POS device 212 of the EFT terminal 208 or the wireless communications module 216 and routes them to a backend server 111 over Ethernet using an illustrative Ethernet protocol. Additionally, the aggregator 218 is configured to transmit the authorization and voucher validation information over the 802.15 wireless network. Furthermore, the data transmitted wirelessly across the network is encrypted with three (3) layers of data security that include tokenization, encryption from the EFT terminal 602, and encryption from an alternate mesh protocol such as DIGIMESH™ which is developed by Digi International. DIGIMESH™ provides security using fixed AES-128 encryption that is configurable, but does not change during normal operation. The third layer of security is provided by using a Derived Unique Key Per Transaction (DUKPT), which is a key management scheme that generates a unique key for every transaction wherein the unique key is derived from a fixed key.

The aggregator 218 is located at specific locations to minimize the need for individual radios, which creates the ability for the 802.15.4 network to handle many nearly simultaneous transactions. In operation, a preliminary path check ensures the ability of the network to fully route transactional information to the desired source.

The illustrative 802.15.4 network also supports the encryption that is necessary for processing financial transactions, confidential information and for system monitoring. The 802.15.4 wireless protocol operates at a frequency that is not readily discoverable by patrons.

Additionally, the illustrative network is configured to eliminate the need for user credentials so that each client wireless communication module 216 and aggregator 218 may use a unique AES key that changes before each transaction or after a period of expiration. The illustrative 802.15.4 wireless protocol enables client devices, systems and methods presented herein to use proprietary protocols that makes it difficult and/or cost prohibitive for a third-party technology to communicate with a CMS system or a SAS system 224.

The illustrative backend server 111 receives transaction data from the aggregator 218. The transaction data is transmitted to master gateway 120, which in turn sends allowable transactions on to the banking processor (not shown) and waits for an authorization message. The banking processor then proceeds to either approve or deny the transaction. If the transaction is denied, then information regarding the denial is transmitted back through the aggregator 218, 802.15.4 mesh network and eventually displayed on the EFT terminal 208 as a “transaction not approved” message.

If the transaction is approved, the backend server 111 transmits the transaction information for the fund transfer request to the SAS 224 through one of a plurality of Slot Machine Interface Boards (SMIBs) 226. The SAS 224 then generates a voucher validation code corresponding to the fund transfer request and logs the voucher validation code along with the approval information for later retrieval and confirmation when a voucher bearing this voucher validation code is redeemed, such as at a slot machine. The SAS 111 then transmits the voucher validation code back to the backend server 111. The backend server can also log the voucher validation code along with the approval information into a database associated with the backend server 111.

Alternatively, the backend server 111 itself uses a seed algorithm to generate a voucher validation code; this voucher validation code along with the approval information is logged in to a database associated with the backend server 111 and then transmitted back through the aggregator 218, 802.15.4 network and the controller eventually displaying a “transaction approved” message on the POS 212. In conjunction with the approval message on the POS Device 212, the slot controller signals the printer sharing board that it wishes to print a voucher. The printer sharing board allows a break in the communication between the EGM 209 and the TITO printer 204. Once there is a break in the communication between the EGM 209 and the TITO printer 204, the shared printer board allows a queued voucher (not shown) to print on the TITO Printer 204.

After the voucher has printed, a confirmation message is sent back through the 802.15.4 network to the aggregator 218 and then to the backend server 111. This message is entered into the backed server database and is also sent to the SAS 224 and a corresponding SAS database (not shown) to let the SAS database store the voucher code that represents a redeemable voucher, e.g. TITO ticket.

The voucher validation code is then transmitted back through the aggregator 218, 802.15.4 network, and eventually to the EFT terminal 208, which displays a “transaction approved” message. In conjunction with the approval message on the EFT terminal 208, the printer 204 receives a signal to print a voucher corresponding to the voucher validation code.

After the voucher has printed, a confirmation message is sent back through the 802.15.4 network to the aggregator 218 and then to the backend server 111. This message is entered into the backed server database and is also sent to a SAS 224 to let the SAS 224 store that the voucher code has been printed as a redeemable voucher, e.g. TITO ticket.

In the illustrative embodiment, the backend server 111 does not communicate directly with the SAS 224. Instead, the backend server 111 is communicatively coupled to a plurality of SMIBs 226 using standard SAS protocols and/or Game to System (G2S) protocols. One of the plurality of SMIBs 226 then communicates with the SAS 224 using the manufacturer's proprietary protocols. Regardless of the number of client devices 208 deployed on a casino floor, the resulting system 200 appears to the SAS 224 as a single slot machine (or multiple slot machines if multiple SMIBs are used) that simply prints/issues TITO tickets. The system 200 enables the patron to receive a newly printed voucher that can be inserted into a bill validator (not shown) corresponding to EGM 209 and an equivalent number of credits will be placed on the game register of the EGM 209 when the voucher validation code is transmitted by the EGM through an associated house SMIB 228 directly to the SAS 224. The SAS 224 confirms that the voucher validation code corresponds to an entry in the SAS 224 for a value corresponding to the fund transfer request and removes the entry as redeemed as the EGM enters the equivalent number of credits on the game register. Alternatively, the patron can also take the printed voucher to a redemption outlet located on the premises.

In this illustrative embodiment, the backend server 111 is also communicatively coupled to a master gateway 120 that includes a “payment gateway,” which is also referred to as a banking gateway. For purposes of this patent, the terms “payment gateway” and “banking gateway” are used interchangeably; however, in general the term “banking gateway” refers to the illustrative slot machine embodiment and “payment gateway” refers to the more general embodiment. The payment gateway is configured to communicate with at least one financial network (not shown). Additionally, the payment gateway is configured to receive an authorization request from the backend server 111, which is associated with an approved transaction.

A master gateway software module 230 resides in the master gateway 120 and includes proprietary software that communicates with the backend server 111. In the illustrative embodiment, the backend server 111 is communicatively coupled to a banking gateway API using a secure network communication protocol. The master gateway 120 is communicatively coupled to one or more financial networks, including but not limited to the PLUS, STAR, CIRRUS, INTERLINK, MONEY PASS, or NYCE networks, that provide access to the server(s) associated with patrons' financial accounts.

By way of example and not of limitation, the backend server 111 is communicatively coupled to the master gateway 120 using the internet that employs an illustrative security protocol such as HTTPS utilizing SSL/TLS. Other security protocols may also be used. The HTTPS protocol provides authentication and protects the privacy and integrity of the exchanged data.

The master gateway software module 230 includes a payment gateway API that is proprietary to at least one specific payment gateway service. In an alternative embodiment, the master gateway 120 does not include banking gateway software; thus, the master gateway 120 represents an external service associated with, but not controlled by, the transactional system. This provides enhanced security by insulating the casino property from financial regulation and liability arising from processing financial transactions. Further, this separation of backend server services and master gateway services provides the necessary flexibility adaptability in the system to service casinos in multiple jurisdictions having separate jurisdictional restrictions upon gaming and gaming related transactions.

In operation, the backend server 111 connects to and exchanges data with the master gateway 120. The transaction is initiated with an outbound EFT request, which is associated with a patron interacting with the EFT terminal 208. Applicable data is forwarded from the terminal 208 to the master gateway 120 via backend server 111 and then to the appropriate financial network associated with the institution or other entity that manages and controls the patron's account. The result of the processed EFT request from the institution or entity is conveyed back to the master gateway 120 via the financial network and then back to the EFT terminal 208 via backend server 111 for further disposition.

More generally, the master gateway 120 is communicatively coupled to the backend server 111 and one or more financial networks. Thus, the master gateway 120 securely communicates with at least one financial network.

The EFT terminal 208 securely communicates the received transactional data to the master gateway through one or more wireless communication module 216 using a 802.15.4 network protocol to the aggregator 218, which is communicatively coupled to the backend server 111.

In one embodiment, if the transaction is approved, then the master gateway 120 communicates that the transaction is an “authorized transaction” and the backend server 111 transmits the transaction information associated with the fund transfer request to the SAS 224 through one of the plurality of SMIBs 226 for generation of a TITO ticket serial number. The TITO serial number and authorization information are then passed back through one of the plurality of SMIBs 226 to the backend server 111 and on to the aggregator 218. The illustrative 802.15.4 network protocol is used from communications between the aggregator 218 and the wireless communication module 216. The wireless communication module 216 then sends the approval message to the EFT terminal 208.

Additionally, when the EFT terminal 208 receives the approval message, the voucher validation code is transmitted to the printer 204, which allows a voucher to be printed by the printer 204. In embodiments where the EFT terminal 208 is a handheld mobile EFT terminal, the voucher validation code is transmitted to an onboard printer included within the handheld mobile EFT terminal, which prints the voucher and/or receipt. The voucher validation number is generated by the SAS 224 and a voucher validation number is communicated to the EFT terminal 208, which then proceeds to instruct the printer 204 to print the voucher and or receipt.

The wireless communication module 216 then wirelessly communicates that the TITO ticket serial number has been printed to the aggregator 218, which then communicates that the TITO ticket serial number has been printed to the backend server 111. In turn, the backend server 111 also communicates to the SAS 224 that the TITO ticket serial number has been printed.

Presently each slot machine or player tracking apparatus is connected to the SAS 224 through wired connections. The client devices, systems and methods presented herein eliminate the need for wiring each individual device, which can be extremely cost prohibitive. More specifically, the illustrative systems and methods substantially reduce the number of wired devices from the thousands to a few dozen aggregators 218.

In yet another embodiment, the master gateway 120 also acts as a gaming regulatory gateway and adheres to limits, rules and standards that are set forth in accordance with specific gaming jurisdictions, configured by a particular licensee (casino), or configured by an individual patron. The master gateway 120 may or may not handle rules and limits for more than one licensee of the transactional system simultaneously, such as handling rules of jurisdiction one for site one and rules of jurisdiction two for site two, as well as configured limits for a licensee and/or patron at site one and separately configured limits for a second licensee and/or patron at site two. The master gateway makes initial determinations based on these limits, rules and standards about whether a transaction should be processed and sent on to the financial network or rejected without being sent.

The master gateway 120 includes or is communicatively coupled to a database containing a plurality of gaming limits and gaming rules that each include a variety of factors used to determine the applicability of a particular gaming limit or gaming rule to a fund transfer request. These factors can include, but are not limited to, temporal factors, geographic factors, and identification factors. Each gaming limit and gaming rule provides a restriction on the number of transactions or total value of transactions during a time period, within a particular location, and attributed to a particular identity. The temporal factors provide granularity to the gaming limit or gaming rule time period, defining the time period of an hour as a trailing period of 60 minutes or 2:00 p.m. to 3:00 p.m., e.g., and defining the time period of a day as a calendar day, a gaming day, or a trailing period of 24 hours. The geographic factors provide granularity to the gaming limit or gaming rule location restriction such as by defining a location as any transactions occurring within a 50 mile radius, within the boundary of a particular State, within the limits of a City, within a Zip Code, within one or more properties of a Gaming Entity, within a single casino property, on a certain floor of a casino, at a particular bank of gaming machines, at a particular gaming machine, at a particular table, or at a particular position of a particular table. Further, the geographic factors may define a casino property as a particular casino location or any casino owned by a certain Gaming Entity, i.e. a particular legal entity such as a corporation. The identification factors provide granularity to the gaming limit or gaming rule identity restriction such as by defining that the gaming rule or gaming limit applies to a particular patron or a particular debit instrument (i.e. per card).

In one embodiment, the master gateway 120 retrieves gaming limits and gaming rules applicable to a fund transfer request, such as by assessing the transaction information associated with the fund transfer request for the location from which the fund transfer request was made by a patron and determining that one or more tribal gaming rules, one or more state gaming rules, one or more federal gaming rules, or any combination thereof applies to the fund transfer request. The master gateway can also assess the transaction information associated with the fund transfer request for the identity of the patron making the request or the particular card associated with the request and determining that one or more gaming limit, such as a problem gaming limit, a House gaming limit, an individual patron limit, or a combination thereof applies to the fund transfer request.

The master gateway 120 further retrieves transaction information for all other transactions related to the fund transfer request based upon the factors defining the applicable gaming limits and gaming rules, i.e. other transactions made by the same patron, or by the same patron within a certain time period. The master gateway 120 can then make an initial determination of whether the fund transfer request is compliant or non-compliant with the applicable gaming limits and gaming rules. The master gateway 120 can also send this initial determination, as well as the retrieved transaction information and gaming limits or gaming rules to the backend server 111 to allow the backend server to make an independent determination of whether the fund transfer request is compliant or non-compliant with the applicable gaming limits and gaming rules.

Upon receipt of the initial determination, retrieved transaction information, gaming limits, and gaming rules, the backend server 111 can make a separate determination of the compliance or non-compliance of the fund transfer request with one or more of the gaming limits and gaming rules. A component of the separate determination of compliance by the backend server 111 is configuration of the gaming limits and gaming rules. The backend server 111 configures the gaming limits and gaming rules with the previously described temporal factors, geographic factors, and identification factors. This process empowers each casino property to independently configure the gaming limits and gaming rules applied and retrieved by the master gateway 120.

This separation of operations as well as the physical separation between the master gateway 120 and the backend server 111 serves to protect casinos from liability arising from storage of financial transaction information on-site and provides built-in redundancy that makes the method and client device for enabling financial transactions more secure and PCI compliant.

However, in an alternative embodiment the master gateway 120 can be located on-site at a particular casino property.

The master gateway 120 also has the ability to apply business based logic rules to initiated transactions. These parameters will determine the optimal transaction routing through the payment networks and can also determine whether or not to deny transactions based on pre-determined criteria.

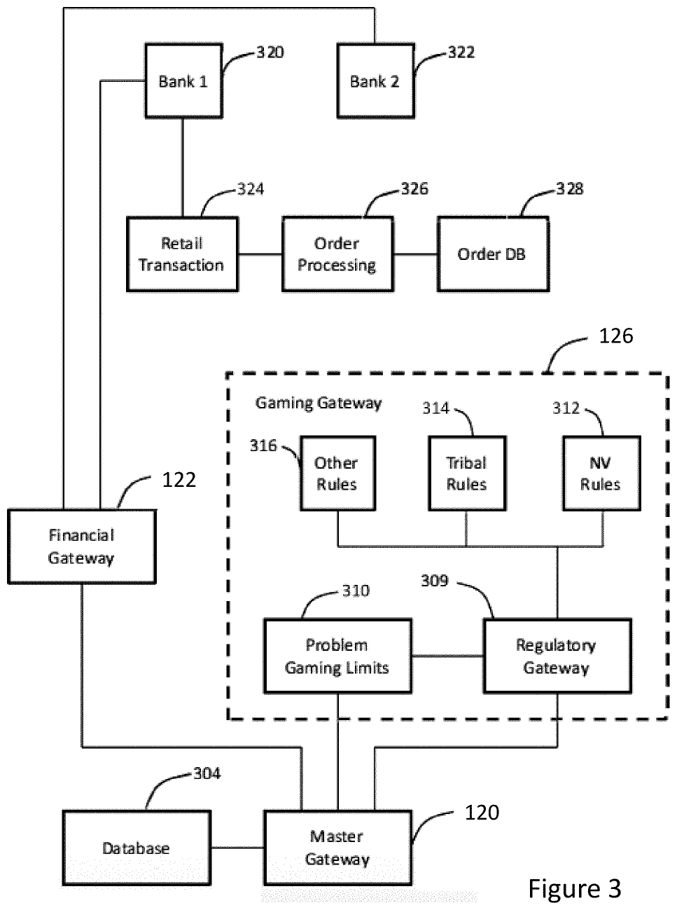

Referring to FIG. 3, there is shown another illustrative embodiment of the master gateway 120 operating as an aggregator. The illustrative master gateway 120 is communicatively coupled to a database 304. Additionally, the master gateway 120 is communicatively coupled to gaming gateway 126 and financial gateway 122.

In one embodiment, the relational database management system 304 enables the master gateway 120 to operate as an aggregator of the gaming gateway 126 rules sets and the transactional information communicated to the financial gateway 122.

The gaming gateway 126 manages and performs the regulatory requirements associated with gaming. By way of example and not of limitation, the gaming gateway 126 may be communicatively coupled to a regulatory gateway 309 and a problem gaming limits module 310. The regulatory gateway 309 includes state rule sets 312, tribal rule sets 314 and other rule sets 316 such as federal gaming rules and other such gaming rules. The problem gaming limits module 310 may include a maximum advisable gaming limit, casino property/house limits, and/or individual daily patron limits. With the exception of the maximum advisable gaming limit at which all withdrawal limits within the problem gaming limits module 310 are initially set (if indeed any value is initially entered for these various other limits), the withdrawal limits included in the problem gaming limits module 310 may be configured by the licensee or patron to which they are attributed. However, this configuration is limited to reductions in the limits from the initial maximum value. For example, a problem gaming limit may initially be set to a regulatory maximum of $1,000/day/payment card/casino. A first licensee may elect to set a house limit at $1,000/day/patron/casino. Thus, the first licensee's house limit would prevent patrons from legally circumventing the regulatory maximum limit by switching from a first payment card to a second payment card, which would allow them to access $2,000 one day in a single casino by splitting the withdrawals among their two cards. In contrast, a second licensee may establish its own house limit of $800/day/payment card/casino, which is less than the regulatory maximum, but would allow a single patron $800 in one day from each of their payment cards. This would provide a patron at the second licensee's casino access to $800 times the number of payment cards that patron can withdraw $800 with on a single day. In these examples, a patron may elect to further reduce their personal daily limit at the first licensee's casino to $800/day and a second personal daily limit at the second licensee's casino to $800/day. This patron would no longer be able to withdraw the house limit of $1,000/day in the first licensee's casino, and would no longer be able to withdraw $800/day from each of multiple payment cards in the second licensee's casino.

The problem gaming rule sets embodied in the problem gaming limits module 310 may also include daily limits or may pause the period during which a person may withdraw funds to allow for a “cool down” period.

The master gateway 120 may also be configured to communicate with the financial gateway 122, which is communicatively coupled to at least one financial network or payment processor. The financial gateway 122 is configured to receive an authorization request, which is associated with an approved transaction.

In the illustrative embodiment, the financial gateway 122 is communicatively coupled to a first bank 320 and a second bank 322. The first bank 320 is also configured to perform retail transactions, not just gaming transactions. The first bank 320 is configured to communicate with a retail transaction module 324, which is operatively coupled to an order processing module 326 that stores the transactional date in the order database 328.

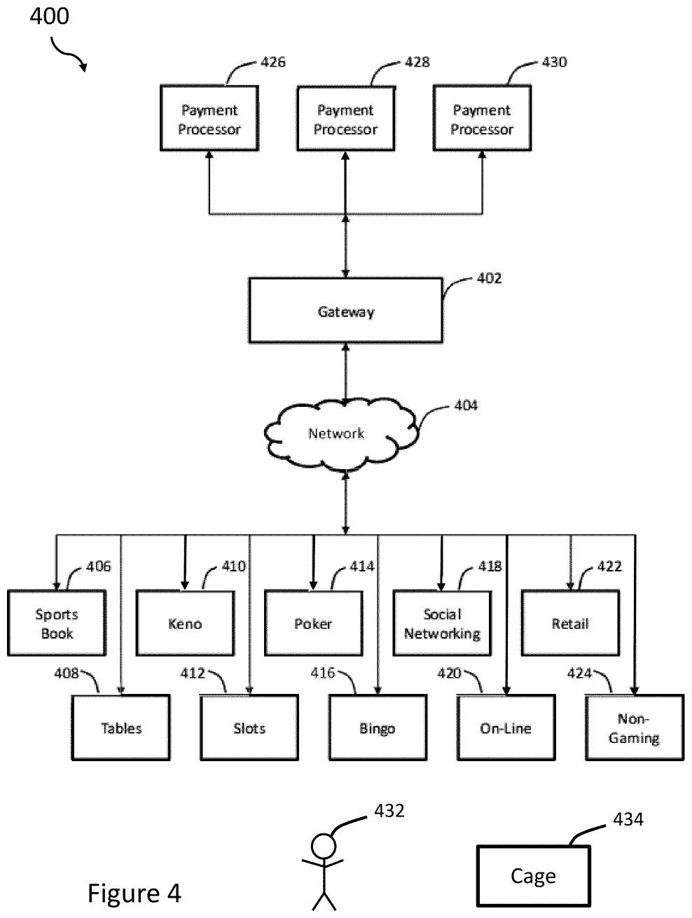

Referring to FIG. 4, there is shown an illustrative embodiment of a transaction processing system 400. The transaction processing system 400 includes a gateway 402 that may embody one or more of the master gateway, the gaming gateway, and/or the financial gateway and may, in addition, perform the functions described herein with respect to any of the gateway systems.

To this end, the transaction processing system 400 may comprise the master gateway, a network 404, and one or more client devices, such as client devices 406, 408, 410, 412, 414, 416, 418, 420, 422, and 424. The transaction processing system 400 may, in addition, comprise one or more payment processors, such as payment processors 426, 428, and 430. A user/patron 432 may interact with the transaction processing system 400 to redeem or exchange a printed record operating as an indicia of value (received from the system 400 and printed at an EFT device as described herein) at a casino “cage” 434 (which may include a chip bank, a plurality of cashiers, and a main bank).

As described above, the gateway 402 may comprise a system configured to receive and process transaction data. In this respect, the gateway 402 may function as a transaction data aggregator, and may comprise one or more logic components (such as one or more controllers or processors) communicatively coupled to one or more tangible, non-transitory, computer-readable media. The logic components may execute instructions stored on the computer-readable media to perform the transaction processing and aggregation operations described herein.

The gateway 402 may be communicatively coupled, by way of the network 404, to the one or more electronic client devices 406, 408, 410, 412, 414, 416, 418, 420, 422, and 424. The gateway 402 may be further communicatively coupled, by way of the network 404, to the one or more payment processors 426, 428, and 430.

Each of the electronic client devices 406-424 may comprise any device configured to receive transaction data. The transaction data may be submitted (as part of a request for funds) by a user or purchaser such as the patron 432.

The client devices 406-424 may therefore comprise EFT devices (as described above). By way of example and not of limitation, the client devices 406-424 may be situated or physically disposed in a casino gaming environment, in a retail environment, in an online purchasing or online shopping environment, and the like.

For example, the client device 406 may be disposed in a sports book, the client device 408 may be disposed at a gaming table, the client device 410 may be disposed at a device for playing keno, the client device 412 may be disposed in a slot machine, the client device 414 may be disposed at a poker table or device for playing poker, and the client device 416 may be disposed at a bingo table or device for playing bingo. Similarly, the client device 418 may be disposed as part of a social networking system, such as a personal or tablet computing device or smartphone, and the client device 420 may be implement as part of an online purchasing system and may comprise, for example, a tablet computing device, a personal computer, or a smartphone. Further still, the client device 422 may be disposed in a retail environment and may comprise a register or a tablet or other retail computing device. The client device 424 (as well as a variety of other client devices) may be further disposed in any other suitable environment, such as a gaming or non-gaming environment.

The payment processors 426, 428, and 430 may, as described above, comprise any payment processor (or banking) systems configured to process one or more transactions. For example, the payment processors 426, 428, and 430 may comprise systems owned and operated by one or more financial institutions for the receipt and processing of requests for funds (e.g., transactions) against debit and credit accounts.

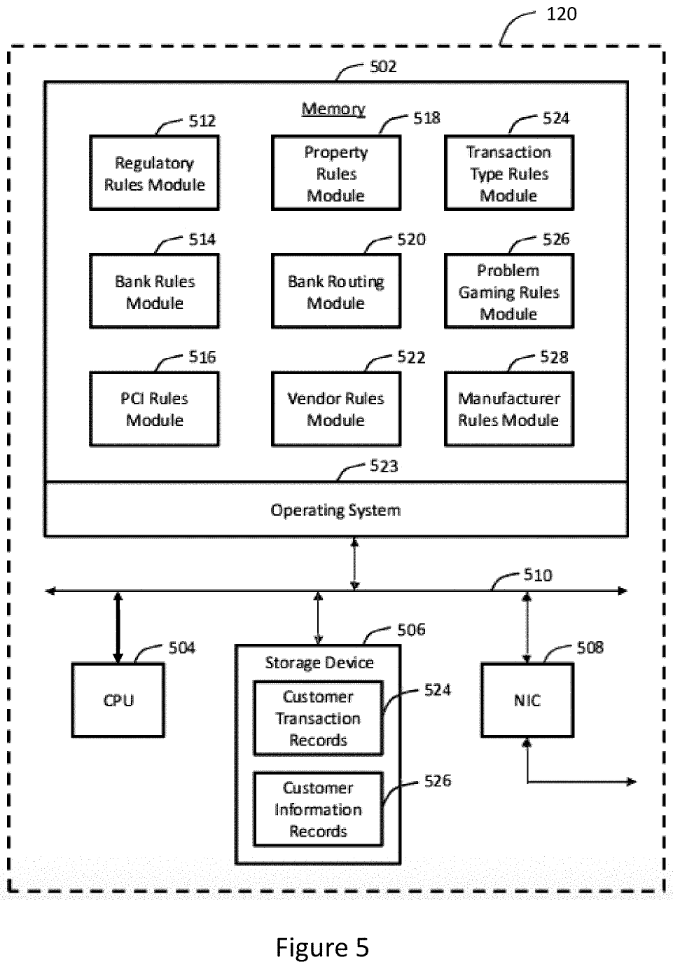

Referring now to FIG. 5, there is shown an illustrative master gateway 120. The master gateway 120 may comprise a memory 502, a logic component 504 (such as a controller or processor, a plurality of controllers or processors, a graphics processing unit or units, an FPGA or FPGAs, and the like), a database 506, and a network interface card (or NIC) 508. The master gateway 120 may further comprise a communications bus 510, which may communicatively couple the memory 502, the logic component 504, the database 506, and the NIC 508. The communications bus 510 may further enable communications between the master gateway 120 and a variety of external systems, such as between the master gateway 120 and devices or systems on the network 404.

The memory 502 may comprise any suitable tangible, non-transitory computer-readable medium configured to store one or more software modules for execution by the logic component 504. The logic component 504 may therefore communicate, via the bus 510, with the memory 502 to retrieve instructions for the execution of one or more software modules stored in the memory 502.

In various embodiments, one or more of the software modules may be stored in a memory that is external to the master gateway 120, in a memory that is internal to the master gateway 120, or a combination of memories, some internal and some external. In addition, as module rules change or are adopted, changing the rules at the master gateway 120 may affect all client devices immediately. Implementation across all client devices based upon a rule change at the master gateway 120 may result in a time and cost savings over having to upgrade thousands of devices over a period of many days or weeks, and may be immediately implemented across an entire jurisdiction or geographical area (e.g., over an entire country). Further, this enables licensees (casinos) and individual patrons to configurable limits unique to each licensee and/or patron from a central or remote access point and implement those configured limits across all client devices.

By way of example and not of limitation, the memory 502 may store a regulatory rules software module 512, a bank rules software module 514, a PCI rules software module 516, a property rules software module 518, a bank routing software module 520, a vendor rules software module 522, a transaction type rules software module 524, a problem gaming rules software module 526, and a manufacturer rules software module 528.

The regulatory rules software module 512 may include a plurality of regulatory rules associated with one or more casino gaming jurisdictions. For example, the regulatory rules software module 512 may specify federal, state, and tribal rules in association with each of a plurality of gaming jurisdictions. These rules may place limitations on transactions occurring within casino gaming establishments and may vary by jurisdiction.

The bank rules software module 514 may include a plurality of bank rules associated with one or more payment processors. For instance, the bank rules software module 514 may specify transaction fees imposed by a plurality of payment processors with which the master gateway 120 is capable of communicating and from which the user 432 may request funds.

The PCI (“Payment Card Industry”) rules software module 516 may include a plurality of security rules for the processing of credit and debit transactions electronically. For example, the PCI rules software module 516 may include rules associated with the PCI Data Security Standard, which may comprise a set of requirements designed to ensure that companies that process, store, or transmit credit or debit card information maintain a secure environment and process those transactions securely. PCI rules may also modify certain financial request data fields to tokenize private information so that it may be stored safely by the master gateway. This modification may include encryption, addition of hash fields or other means to protect the information from unauthorized access and usage.

The property rules software module 518 may include a plurality of rules associated with a casino gaming property. For example, the property rules software module 518 may specify transaction amount limits, daily transaction limits, limits imposed on particular patrons (such as limits imposed on frequent casino patrons or patrons holding markers with the casino property), one or more configurable limits, and the like.

The bank routing software module 520 may include a plurality of rules for routing a request for funds to a particular payment processor. For example, the bank routing software module 520 may specify that particular request for funds should be routed to a particular payment processor based upon a lowest transaction fee. The bank routing software module 520 may also specify that a particular request for funds should be routed to a secondary payment processor in the event that an initially selected payment processor declines the request for funds or is otherwise unavailable to process the transaction.

The vendor rules software module 522 may include a plurality of rules associated with the client device vendor. For instance, where the client device is associated with a casino game, the vendor rules software module 522 may include rules that are particular to the game or client device associated with the game.

The transaction type rules software module 524 may include a plurality of rules for determining a transaction type associated with a request for funds. For example, a request for funds may be associated with a transaction type code. The transaction type code may specify a transaction type, and the transaction type rules software module 524 may be used to determine, based upon the code, the transaction type associated with the request for funds. By way of example and not of limitation, the request for funds may be associated with a gaming transaction type, a retail transaction type, a cash withdrawal transaction type, an online transaction type, and the like.

The problem gaming rules software module 526 may include a plurality of rules for determining whether a request for funds has been made by a user 432 associated with a problem gaming status or with a user 432 who has been identified as an individual not permitted to participate in a casino game or who has otherwise applied a status of “self-excluded,” meaning that the individual has requested that the gaming establishment deny requests for funds made by the individual within the gaming establishment, such that the individual is prohibited or prevented from making requests for funds in connection with gaming activities on the property. The problem gaming rules software module 526 may further include one or more configurable limits.

The manufacturer rules software module 528 may include a plurality of rules associated with a client device manufacturer. For instance, where a client device 406-424 is associated with a casino gaming, such as a slot machine work table game, the manufacturer rules software module 528 may include rules that are particular to the game or client device associated with the game.

The memory 502 may further include an operating system or operating system software module 522. The operating system 523 may comprise the operating system or operating system software for the master gateway 120. As such, the logic component 504 may execute the operating system 523 to perform the operations and functions, as described herein, associated with the master gateway 120.

The database 506 may comprise a tangible, non-transitory, storage medium. The database 506 may further comprise any suitable database structure for storing the plurality of data records. For example, the database 506 may comprise a relational database structure configured to store transaction and user data records. By way of example and not of limitation, the database 506 may include a user transaction records table 524 and a user information records table 526. The user transaction records table 524 may include transaction data associated with each of a plurality of users. The transaction records may include the time, date, payment card, transaction amount, and patron identification. The transactions records may be encrypted, such as by hashing, to safeguard licensee casino properties from hacking and liability resulting therefrom. The user information records table may include other data associated with the plurality of users such as, for example, user profile data, user demographic data, user credit history data, user gaming history data, and the like.

The logic component 504 may communicate, via the bus 510, with the database 506 to retrieve and store user transaction data information and user information for a variety of purposes, such as, for example, player tracking, funds requests processing, and the like.

The NIC 508 may permit the master gateway 120 to communicate with a plurality of other devices or systems via the network 404. The NIC 508 may further permit the master gateway 120 to receive transaction and other data from sources external to the master gateway 120. The NIC 508 may utilize well known networking protocols to communicate with the other networked devices. These protocols may include Ethernet type protocol, TCP/IP protocols, and other such protocols.

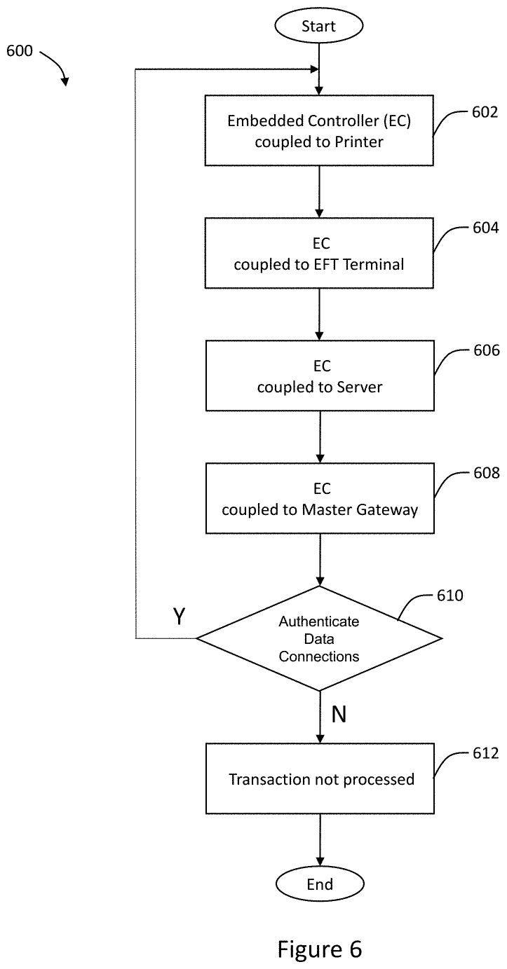

Referring to FIG. 6, there is shown a flowchart 600, in which the controller 102 is establishing and monitoring the data connections with the printer 104, 204, EFT terminal 108, 208, backend server 111, and master gateway 120.

Custom and proprietary software running on the controller 102 establishes the three secure data connections that include: 1) a secure encrypted connection with the EFT terminal 108, 208, in which the necessary custom and proprietary software is active and configured to begin a new transaction; 2) a secure encrypted connection with the master gateway 120; and 3) a secure encrypted connection with the backend server 111. Once all three data connections are established by the controller 102, the transactional system is considered to be online, active, and accordingly, the illustrative EFT terminal 108, 208 is available for a patron to initiate the transactional process.

At block 602, the controller 102 is communicatively coupled to the printer 104, 204. In the illustrative embodiment, the controller 102 and printer 104, 204 communicate via a local communication protocol such as, but not limited to, RS-232, USB(X).(Y), SPI, I2C, RS-422, RS-485, IEEE 1394, or the like. By way of example and not of limitation, a protocol conversion interface or controller board may be utilized between the controller 102 and the printer 104, 204 to establish a secure data communication path between the two devices utilizing available or desired ports in each one.

At block 604, the controller 102 is communicatively coupled to the EFT terminal 108, 208. The secure data connection between the controller 102 and the EFT terminal 108, 208 is established with at least one security protocol. The secure data connection may be a wired or wireless communication. The wireless connection may be provided with Bluetooth™, 802.1(x)(y), IR, near-field communication, or any other suitable wired or wireless two-way communication protocol. Security for the data exchanged between the EFT terminal 108, 208 and the controller 102 may be obtained via use of any secure encryption protocol such as AES-256, other private key encryption methods, public key infrastructure (“PKI”) methods, HTTPS, SSL, TLS, and other such security encryption protocols.

In the illustrative embodiment, there are three security operations performed to manage and control communications between the controller 102 and the EFT terminal 108, 208. The at least two security operations also provide device authentication.

One security operation uses encryption to secure the communications between the EFT terminal 108, 208 and the controller 102 by way of example and not of limitation, the second security operation uses AES-256 encryption. AES-256 operates using a single private key, which is shared between the EFT terminal 108, 208 and the controller 102.

Another security operation uses a proprietary security format. The illustrative proprietary security format may use packet length and a checksum function or checksum algorithm. The illustrative checksum functions are related to hash functions, fingerprints, randomization functions and cryptographic hash functions.

In one embodiment, the EFT terminal 108, 208 sends encrypted data using AES-256 encryption or PCI compliant Derived Unique Key Per Transaction (DUKPT) encryption, including all data containing patrons' PIN information.

At block 606, the controller 102 is communicatively coupled to the backend server 111. The controller is configured to connect to a database or database server, which provides logging, accounting, transactional management and reconciliation services. In the illustrative embodiment, the controller is also communicatively coupled to backend server 111.

At block 608, the controller is communicatively coupled to the master gateway 120. At least one proprietary software application runs on the controller 102. By way of example and not of limitation, the proprietary software applications may include one or more application programming interface(s) required to access the master gateway 120 and financial network(s) through which EFT requests will be submitted and processed.

The method then proceeds to decision diamond 610, in which the data connections are monitored and authenticated. More specifically, the controller and the data connections with the POS terminal, the master gateway 120 and the backend server 111 are constantly monitored. If a disconnection of the data connection is detected, then the transactional system automatically attempts to reconnect.

If any of the connections between the controller 102 and the EFT terminal 108, 208, the master gateway 120 and the backend server 111 are disconnected, then the method proceeds to block 612 and transactions cannot be processed.

The custom and proprietary software 116 running on the controller 102 continually performs a number of background processing functions. For example, at one second intervals, configuration information from the EFT terminal 108, 208, the controller 102, the printer 104, 204, and all components and subsystems directly associated with those devices are read from a database resident on the backend server 111 and/or the master gateway 120. Such data may include the name of the establishment, transaction fee amounts and the like. If any configuration changes are identified, the custom proprietary software running 116 on the controller 102 reconfigures any or all such data on the devices. Additionally, the status of the EFT terminal 108, 208 is also monitored, and in the event of connectivity or hardware failure, a connection to a replacement EFT terminal 108, 208 may be initiated.

The controller 102 is also configured to perform other background processing functions including monitoring the connection to the backend server 111 and reestablish the connection if required. The controller 102 also requests the status of the dedicated printer 104, 204 over the appropriate connection port, such as RS-232, to determine such factors as whether the printer 104, 204 is online or offline, the availability of sufficient paper in the printer 104, 204, the presence of any paper jams or other adverse mechanical conditions, and the like. Additionally, the controller 102 monitors the connection to the EFT terminal 108, 208 by polling the EFT terminal 108, 208. If no reply is received within a predetermined time, then the EFT terminal 108, 208 is either not present or not functional. Furthermore, the controller 102 monitors the transaction database table resident on the backend server 111 for transactions that need to have a printed record operating as an indicia of value, such as tickets, or patron receipts reprinted. Further still, the controller waits for transaction initiation requests from the EFT terminal 108, 208.

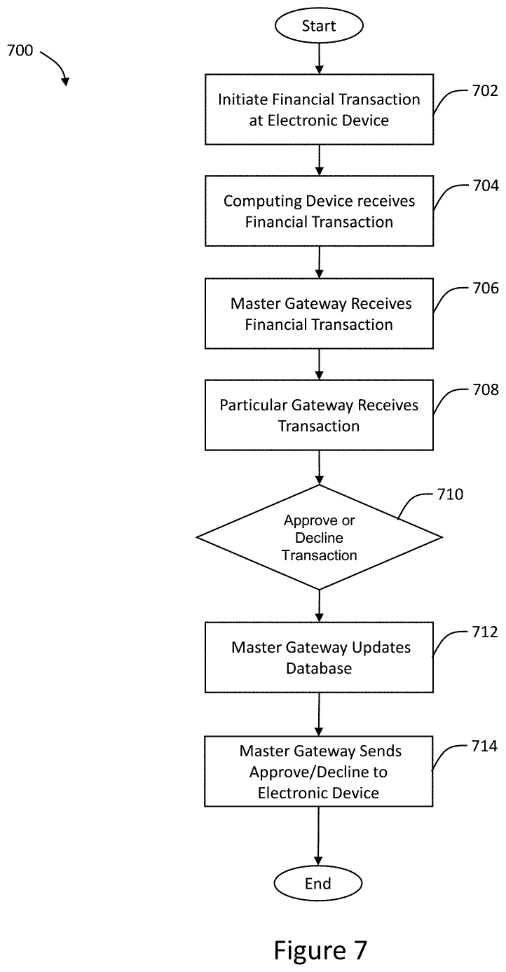

Referring to FIG. 7, there is shown a flowchart of the various operations performed by an illustrative master gateway. The method 700 is initiated at block 702 where a transaction is generated by use of equipment, such as the EFT terminal 108, 208, designed to accept payment cards by way of mag-stripe, EMV, NFC or other electronic means. The transaction includes such details as account number, cardholder information, amount of transaction (inclusive of any charged fees), and a verification/identification number. In various embodiments, one or more approval gateways, as described herein, may provide PCI compliance, which may eliminate the necessity of the performance of PCI compliance rules by other (multiple) entities, such as one or more banking gateways or payment processors.

The method then proceeds to block 704 where the transaction information is routed through one or more computing devices that log transaction details into a database via electronic networks and also forward the transaction details along to one or more ‘approval’ gateways, such as the master gateway 120.

At block 706, the transaction information is communicated to a master gateway that is communicatively coupled to one or more “Approval” gateways that include, but are not limited to, the banking/financial gateway 122, and one or more gaming gateways 126, that each handle the transaction in serial or parallel. Each gateway is responsible for assessing the transaction, applying business rules and requirements, and providing an ‘authorize’ or ‘decline’ result back to one or more of the computing devices that issued the transaction, which may also include an aggregator 218.

The appropriate gateway receives the transactional information at block 708 and processes the transactional information according to the logic or rule set corresponding to the particular gateway. More specifically, each gateway, may, in turn, route the request to additional gateways for additional approval requirement processing. For example, a gateway that is responsible for reducing fees charged to process a transaction may look at card information and/or amount information and route the transaction to a specific banking gateway that will charge less based on amount and/or card type.

At decision diamond 710, a determination is made whether the particular gateway has algorithmically determined an approval or denial, either by a gateway's logic or other communicatively coupled gateway that it used in processing the transaction, it returns the decision to the backend server 111 from which the request was sent, and ultimately back to the EFT device 108, 208 that requested the decision.

The results from decision diamond 710 are also communicated from the appropriate gateway to the master gateway 120. The master gateway 120 aggregates the results from each of the particular gateways.

At block 712, the master gateway 120 updates the appropriate database with all necessary information about the transaction. The master gateway 120 also provides a final approval to the original requestor of the transaction. Additionally, the master gateway 120 may also communicate that the transaction has been declined. A final ‘approval’ would require unanimous approvals from all upstream gateways and aggregators, unless additional business logic provides for a lesser amount. Further still, where the approval provided by the master gateway 120 is an initial determination, this initial determination and the various factors contributing to it are transmitted to the backend server 111 for an independent determination, which then becomes the final determination and/or approval.

At block 714, the electronic client device (e.g., EFT terminal 108, 208) that initiated the transaction communicates that the transaction has been approved or denied. For example, the original transaction generating computing client device would then a) in the case of an approval, issue funds and or indicia of credit to the player, along with a receipt, or b) in the case of a denial, providing the patron with a message stating declined and optionally, a reason or reason code.

The system architecture that supports the operations performed by the illustrative master gateway 120 and the other specialized gateways may operate on individual computing devices or distributed across multiple computing systems via electronic communication.

The illustrative gateways 120, 122, 126 and aggregators 218 can be located anywhere in the data path from the patron interface all the way back to the banking network. They also can be local to the casino, or external to the casino.

Depending on the particular embodiment, each gateway 120, 122, 126 or aggregator 218 will optionally update a database with transaction information in internal or external databases which provide accounting, validation, verification and auditing ability. At least one gateway 120, 122, 126 and/or aggregator 218 will record all information in a database external to casino (e.g., database 304), and identify those transactions by originating location and/or property.

In one illustrative embodiment, a transaction may also be optionally coded with an ID that identifies the source of the transaction and/or what product or service is requested. This allows gateways 120, 122, 126 to apply different business rules based on the type of transaction. For example, a casino patron may wish to order a drink from the gaming device, and this transaction would be coded differently than a request for credits on a gaming device 406-416 and/or EGM 209 used for wagering. In the former case, gaming related business rules may be omitted, but retail business rules may be applied.

Business rules applied to gaming transactions may be, but are not limited to, amount of transaction, fees applied, type of payment card, date and time, frequency of use or “velocity” (e.g., the same customer may only withdraw funds every 15 minutes), player identification, total amount withdrawn over a period of time, cost of transaction, location of originating device, casino minimums and maximums, regulatory minimums and maximums (i.e., per transaction, per day, per device, per payment card, per individual).

The illustrative gateways 120, 122, 126 or aggregators 218 may be communicatively coupled to an EFT terminal 108,208 that is disposed in or near a slot machine 206 or a casino table game. By way of example and not of limitation, the casino table game includes card games such as Blackjack (also known as “21”), Poker, Pai Gow, Baccarat, and other such card games. Additional illustrative table games include, but are not limited to, wheel games such as roulette and dice games such as craps, Sic Bo and other such dice games.

In the illustrative embodiment, the gaming gateway system and method does not dispense cash, like a typical Automated Teller Machine (ATM). In another embodiment, the gaming gateway system and method dispenses other indicia of value, e.g. loyalty points or gift cards.

The gaming gateway system and method may be easily relocated, for example, to a patron's point-of-play, thereby facilitating game play. Additionally, the gaming gateway system and method eliminates the need to restock an unattended machine with cash. Furthermore, the gaming gateway system and method operates with fewer complex mechanical components.

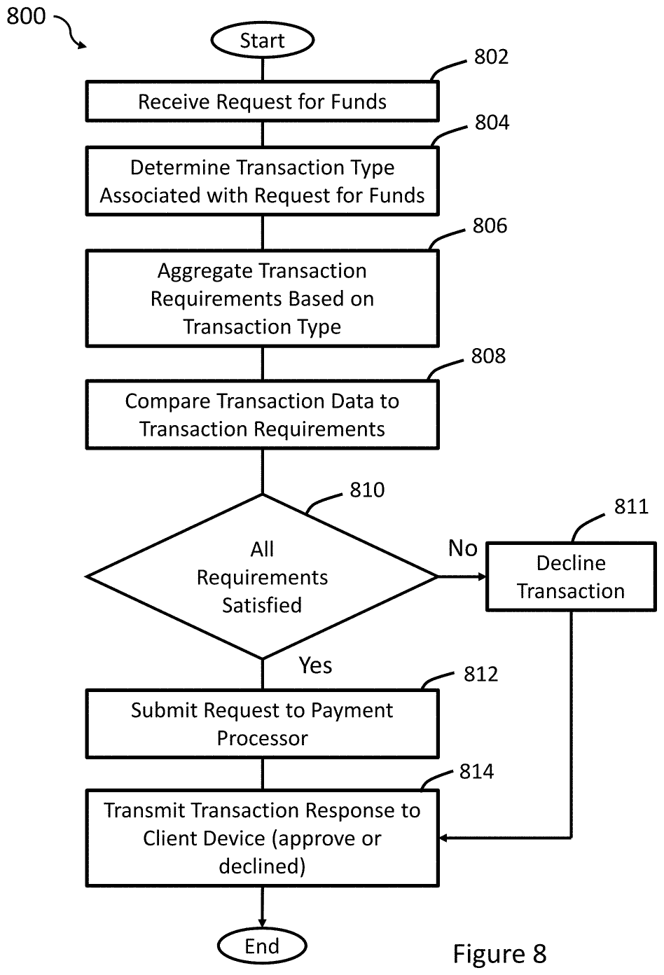

In operation, and with reference to FIG. 8, a flowchart 800 associated with a process for processing a transaction is shown. Accordingly, at block 802, the master gateway 120 may receive a request for funds. The request for funds may be provided by the user 432 of a client device 406-424 or EFT terminal 108, 208. For instance, the user 432 may interface with one of the client devices 406-424 or EFT terminal 108, 208 in a casino gaming property to request funds during game play. More particularly, the user 432 may provide a payment card, such as a credit or debit card, to an input interface of one of the client devices 406-424 or EFT terminal 108, 208 to initiate a request for funds. The client device 406-424 or EFT terminal 108, 208 may read the payment card to obtain transaction information, such as a credit or debit account identifier and an amount associated with the request for funds, and in response, the client device 406-424 or EFT terminal 108, 208 may transmit the transaction information upstream to the master gateway 120.

At block 804, the master gateway 120 may determine the transaction type associated with the request for funds. To determine the transaction type, the logic component 504 of the master gateway 120 may execute the transaction type rules software module 524 stored in the memory 502.

More particularly, and as described herein, the request for funds may be associated with an identifier or code, which the logic component 504 may, in association with the transaction type rules software module 524, compare to a list of transaction type codes provided by the transaction type rules software module 524 to determine the transaction type. Where, for example, the code is a gaming code, the logic component 504 may determine that the funds request is associated with a gaming transaction, such as a transaction occurring at a slot machine or table game on a casino property. Similarly, where the code is a retail transaction code, the master gateway 120 may determine that the transaction type associated with the request for funds is a retail transaction.

At block 806, the master gateway 120 may aggregate a plurality of transaction requirements necessary for processing the request for funds based upon the determined transaction type. More particularly, the master gateway 120 may execute one or more software modules 512-520 based upon the determined transaction type. Transaction requirements may include a plurality of regulatory rules requirements, one or more bank rules requirements, a one or more of PCI rules requirements, one or more property rules requirements, one or more vendor rules requirements, one or more problem gaming rules requirements, one or more manufacturer rules requirements, one or more configureable limits, and one or more bank routing requirements.

By way of example and not of limitation, where the logic component 504 determines that the transaction type is gaming, the logic component 504 may further determine that it is necessary to execute the regulatory rules software module 502 to retrieve regulatory rules requirements for processing the gaming transaction. Each of the regulatory rules necessary for processing the funds request may be added to a list or table of transaction requirements for the funds request. Similarly, the logic component 504 may execute the problem gaming rules software module 526, which may add to the aggregated list of transaction requirements a requirement that the user requesting funds is not excluded from game play on the casino property from which the request for funds originates.

In contrast, where the transaction type is retail, the logic component 504 may determine that it is not necessary to execute the regulatory rules software module 502 (because retail transactions are not subject to gaming regulations). Rather, in the instance that the transaction type is retail, the logic component 504 may only execute the bank rules software module 514, the PCI rules software module 516, and the bank routing module 520 to generate the list of transaction requirements necessary for processing the request for funds.

At block 808, the logic component 504 may analyze the transaction data associated with the request for funds and other data associated with the user 432 (such as data stored in the user information records table 526 of the database 506) to populate answers to each requirement in the aggregated list of transaction requirements. For example, at decision diamond 810, the logic component 504 may compare transaction data and user data to each of the transaction requirements to determine whether each of the transaction requirements associated with the request for funds is satisfied. The logic component 504 may further update the list or table of transaction requirements with information indicating whether each of the requirements necessary for processing the request for funds is satisfied.

If all of the transaction requirements are satisfied, at block 812, the logic component 504 may submit the request for funds to one of the plurality of payment processors 426-430, i.e. financial network. More particularly, the logic component 504 may submit a request for funds to one of the plurality of payment processors 426-430 in response to a determination that the transaction and user data satisfies all of the requirements in the list of transaction requirements. In other words, the logic component 504 may pass the request for funds on to a payment processor 426-430 if the transaction requirements associated with the request for funds are unanimously satisfied.

However, as shown at block 811, where the logic component 504 determines that at least one of the requirements in the list of transaction requirements associated with the request for funds is not satisfied, the logic component 504 may decline the request for funds and may not transmit the request for funds upstream to a payment processor 426-430.

In various embodiments, it is important to vet a request for funds prior to transmittal of the request to a payment processor 426-430, because the payment processor 426-430 may impose a transaction fee on the request for funds even when the payment processor 426-430 declines the request for funds. In other words, the logic component 504 of the master gateway 120 may vet a request for funds prior to the imposition of a transaction processing fee by a payment processor 426-430 to avoid the payment processor fee in the event that a requirement in the list of transaction requirements is not satisfied.

At block 814, the logic component 504 may transmit a transaction response to the client device 406-424 associated with the request for funds. The transaction response may comprise a message indicating that the request for funds has been approved or declined, either by the master gateway 120, or by the selected payment processor 426-430. The transaction response may further include an electronic record operating as an indicia of value, a printed record operating as an indicia of value, a receipt, a voucher, and the like.

In an illustrative embodiment, the logic component 504 may submit a request for funds that has been declined by an initially selected payment processor 426-430 to a secondary payment processor 426-430. The initially selected payment processor 426-430 may be associated with a lowest transaction fee which as determined by the logic component 504 based upon the bank rules software module 514 or the bank routing software module 520. The secondarily selected payment processor 426-430 may be associated with the transaction fee that is greater than the transaction fee associated with the initially selected payment processor 426-430, but which is otherwise available to process the request for funds when the initially selected payment processor has declined to process the request or is otherwise unavailable. Thus, the logic component 504 may attempt to locate a payment processor 426-430 that will approve the request for funds, even when one or more other payment processors 426-430 have declined the request.

The master gateway 120 may, by way of example and not of limitation, impose a secondary master gateway processing fee on the request for funds. The master gateway 120 may impose this fee prior to submitting the request for funds to a payment processor 426-430 or after submitting to request for funds to a payment processor 426-430. The master gateway 120 may further impose the master gateway fee irrespective of the approval decision of the payment processor 426-430. Thus, the master gateway 120 may collect a transaction fee from a user in response to a request for funds even when a payment processor 426-430 is not selected (e.g., because one or transmitted to a payment processor 426-430), or when one or more selected payment processors 426-430 have declined the request for funds.

The master gateway 120 may further, in response to approval of a request for funds by a payment processor 426-430, generate and transmit an electronic record operating as an indicia of value, a printed record operating as an indicia of value, a receipt, and/or a voucher to an EFT component of the client device from which the request for funds originated, and the client device 406-424 (or the EFT component thereof) may display or print for the user 432 the electronic record, printed record, receipt, and/or voucher for use within the casino. The user 432 may collect the electronic or printed record operating as an indicia of value, the receipt, and/or the voucher, and may submit the record, receipt, or voucher to the cage 434 in exchange for another printed record operating as an indicia of value, such as casino chips, cash, a prepaid casino credit or debit card linked to a player tracking or loyalty account, and the like.

The master gateway 120 may therefore, as described herein, function as an aggregator of transaction requirements and, based upon those requirements, an aggregator of transaction data collected in association with those requirements. In other words, the master gateway 120 may function as a checkpoint or preprocessor through which the request for funds must pass prior to submission, via the master gateway 120, to one or more payment processors 426-430.

This network structure may accommodate a variety of requests for funds, including requests for funds originating from gaming client devices, such as slot machines and table games, located on casino properties. Patrons of casino properties may benefit from the implementation of the master gateway 120 as part of a transaction processing network structure, because the master gateway 120 may permit and enable transaction submission and processing directly from one or more casino client devices such a table games, sports books, keno devices, slot machines, poker tables, bingo games, and the like. In other words, the master gateway 120 may permit the user 432 to continue playing or wagering at a particular casino game without in necessity of retiring from the game in the middle of game play to acquire new or additional funds.

The network structure described with respect to the system 400 may further satisfy the complex web of transactional, regulatory, and security rules governing requests for funds that take place within casinos. Importantly, the system 400 does not operate as a simple mechanism for circumventing these rules (e.g., as an ATM machine located within a casino). Rather, the system 400, as described herein, enables rule determination and compliance in real time and at any client device enabled to receive a transaction instrument, such as a credit or debit card.

The system 400, and more particularly the master gateway 120, may therefore embody an improvement over existing transaction processing systems, particularly over transaction processing systems configured to process gaming transactions, in that the master gateway 120 enables the aggregation and preprocessing of a variety of transaction and user data at the master gateway 120. The master gateway 120 may therefore satisfy a variety of regulatory and transaction processing requirements at a centralized processing hub, which may in turn, reduce the complexity of the transaction processing system and improve the processing or preprocessing speed of the system as a whole. Other advantages include, as described herein, transaction processing at a client device, particularly at the gaming client device within a casino and during game play, real-time protection for individuals associated with a problem gaming status as well as for casinos serving those individuals, transaction fee optimization and real-time payment processor selection, player tracking, and the generation buy-in the master gateway 120.

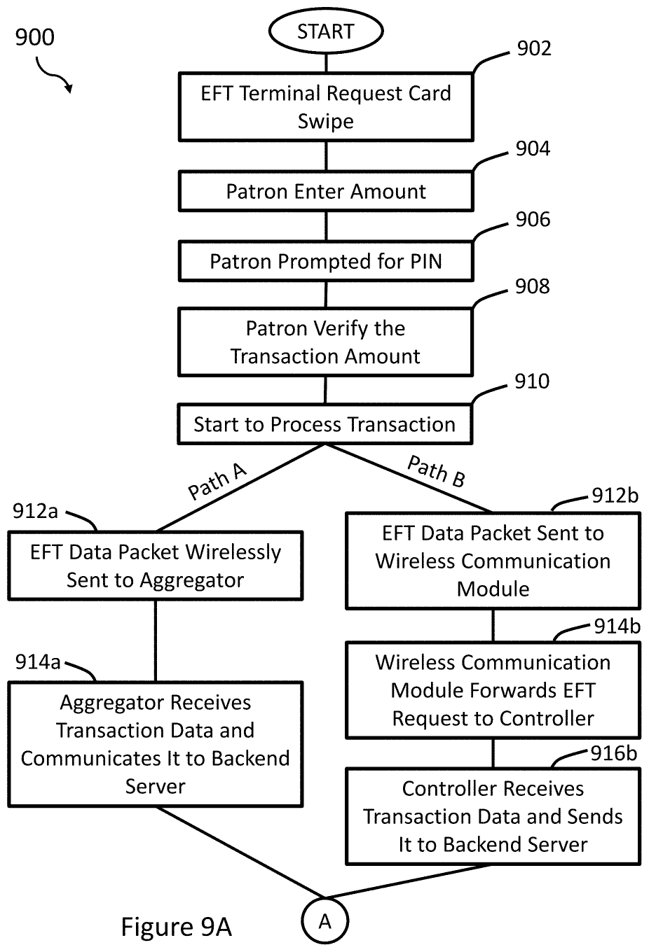

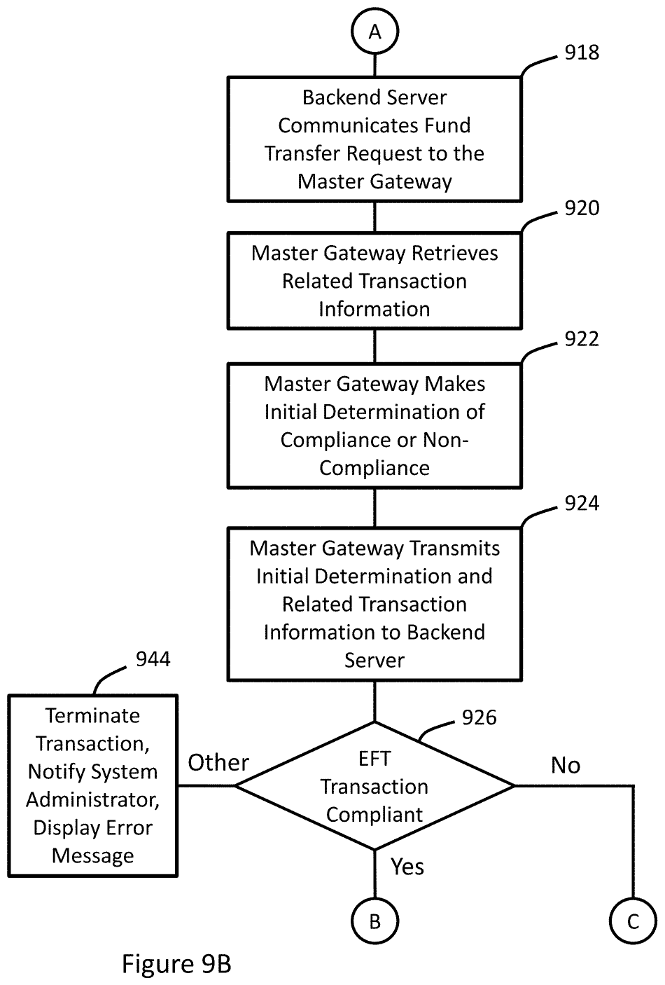

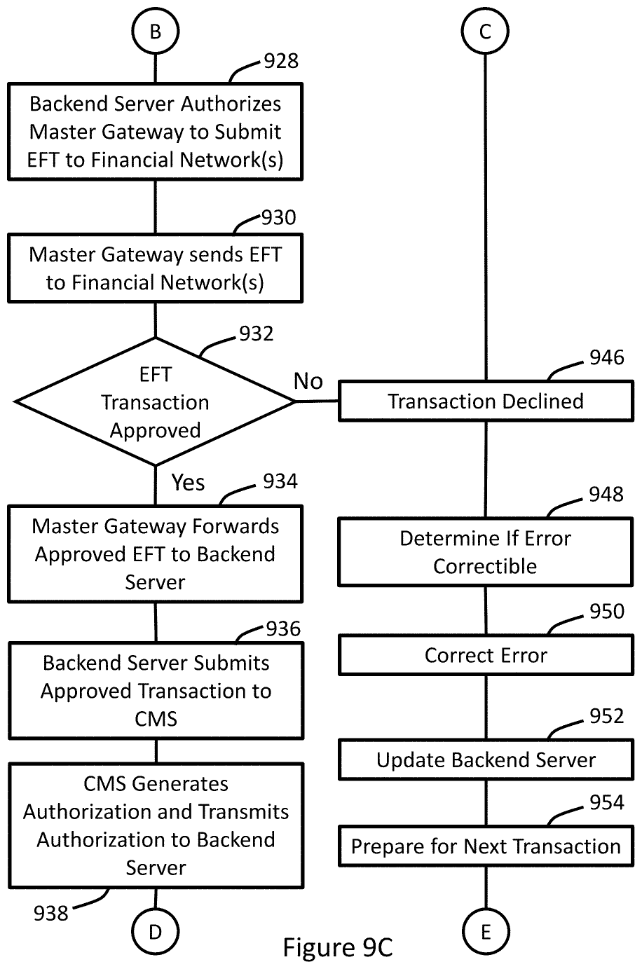

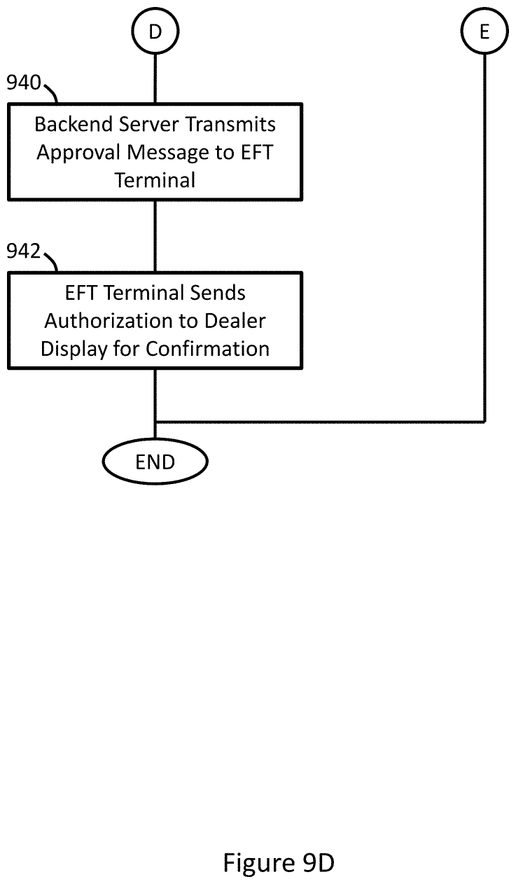

With reference now to FIG. 9A, there is shown a flowchart of an illustrative method 900 for initiating a transaction with an EFT terminal located at a table game 120, 130, 140, 150. The method is initiated at block 902 when the end user, e.g. casino patron, interacts with an EFT terminal using an electrically encoded card. By way of example and not of limitation, the electrically encoded card is a magnetically encoded card, e.g. a debit card. The term “electrically encoded card” refers to any card or physical token that can be electrically encoded such as smart cards, chip-based cards, mobile payment systems (e.g. Apple Play) that include a mobile device such as a smartphone, a magnetic strip card, and other such electrically encoded card. Note in this patent, the magnetically-encoded card is also interchangeably referred to as a magnetic stripe card or “mag stripe” card.

Other technologies may be used in a manner similar to the electrically encoded card to initiate a transaction that transfers funds. For example, transactional smart card(s), RFID tag(s), secure electronic memories, near-field communications, optical media, multi-factor authentication, X.509 certificate authentication, physical biometric data, behavioral biometric data, character or pattern recognition data, alphanumeric login/password authentication, and the like may be used in lieu of the electrically encoded card. These illustrative examples are intended to be representative of the flexibility of the system disclosed herein and are not limiting in any way. It is envisioned that new and improved systems and methods of electronic commerce identification and authentication may be adapted or integrated with the transactional system and method presented herein.

In the illustrative embodiment, the patron obtains funds by swiping the patron's electrically encoded card, which is associated with the user's banking account, and enters information necessary to authenticate, define, and accept any associated terms of the transaction. For example, the custom and proprietary software running on the EFT terminal 108, 208 displays and instructs the illustrative casino patron via a display with a command, such as “Swipe Card to Begin”. After the patron has swiped a card associated with an account which the patron owns or is authorized to access, the patron is then instructed to “Enter an Amount”.

The method then proceeds to block 904 where the end user, e.g. casino patron, enters the amount to withdraw. By way of example and not of limitation, the amount is checked by the EFT terminal software 114 for validity (too low, too high, zero), and if the requested amount is acceptable, the patron is then prompted to enter the PIN associated with the chosen account. The PIN data is received directly by the secure PCI-compliant software embedded in the EFT terminal 108, 208 and is immediately secured via DUKPT encryption. In the illustrative embodiment, no other software or applications running on the EFT terminal 108, 208 are granted access to the illustrative patron's encrypted PIN data.

At block 906, the end user is prompted for a PIN, which is typically associated with a debit card. The method then proceeds to block 908, where the end user verifies the transaction amount, the processing fee, convenience fee or other such fee associated with the transaction. The amount or rate of the fee may be shown to the patron in advance to comply with regulatory requirements pertaining to consumer financial transactions.

For example, following the successful receipt and encryption of the PIN data, the transaction fee is calculated by the custom and proprietary software running on the EFT terminal 108, 208 based on data obtained from an SQL database resident on the illustrative database server. After the end user accepts the transaction and associated fee the method proceeds to block 910 where the transaction is processed.

After block 910, the method splits into two alternative paths for communication of an EFT request from the EFT terminal 108, 208 to the backend server 111. Along Path A at block 912a, an appropriate data packet corresponding to the transaction is generated by the EFT terminal 108, 208. The data packet is then communicated from the EFT terminal 108, 208 to the aggregator 218 using a secure communications protocol as described previously. The aggregator 218 collects such data packets from one or more EFT terminals spread through a region or floor of a casino.

At block 914a, the aggregator 218 receives the transactional data, i.e. the fund transfer request, and communicates the transactional data to the backend server 111. In this Path A embodiment, the aggregator 218 is associated with one or more EFT terminals 108, 208.

Alternatively, along Path B at block 912b, the appropriate data packet corresponding to the transaction is generated by the EFT terminal 108, 208. The data packet is then communicated from the EFT terminal 108, 208 to the wireless communication module 110, 210 using a secure communications protocol as described previously.

At block 914b, the wireless communication module 110, 210 communicates the transaction, i.e. fund transfer request, from the EFT terminal 108, 208 to the controller 102. And at block 916b the controller 102 forwards/communicates the fund transfer request on to the backend server 111. The communication of the fund transfer request in blocks 914b and 916b may also be compressed into a single step where the communication of the fund transfer request is directly and wirelessly from the wireless communications module 110, 210 to the backend server 111, instead of from the wireless communications module to the controller 102, then through a wired connection from the controller 102 to the backend server 111 as in blocks 914b and 916b. In the Path B embodiment, each wireless communication module 110, 210 located in/at a particular gaming table, EGM, or slot machine may be associated with a particular EFT terminal 108, 208.

Each of these alternate paths for the method of initiating a transaction permits end users, e.g. casino patrons, to draw funds electronically from a financial account which they own or are authorized to access, provided that the account has been enabled to permit such transactions. The transactional system and method presented herein may transfer funds from any account which permits such transfer via an electronic system or method provided that the patron has properly and independently established such ability in accordance with the requirements of the account administrator(s) in advance.

Referring to FIG. 9B, there is shown a continuation of the flowchart of the method 900 for initiating a transaction with the EFT terminal 108, 208. The method then proceeds to block 918 where the backend server 111 communicates the transactional data to the master gateway 120. At block 920 the master gateway 120 retrieves transaction data for transactions related to the fund transfer request from a database associated with the master gateway 120. Related transactions can be previous transactions made by the same patron, previous transactions made by the same swipe or debit card, transactions made by the same patron or card occurring during a particular time period, e.g. within the last 24 hours. The selection of related transactions can be made based upon gaming limit and gaming rule factors for gaming limits and gaming rules that are potentially applicable to the location from which the electronic fund request was made, i.e. the casino property, the State, or Reservation. In an alternative embodiment, the master gateway 120 submits the fund transfer request to a financial network(s) as in block 528 prior to retrieving transaction data for transactions related to the fund transfer request. In the alternative embodiment, the master gateway 120 retrieves transaction data for transactions related to the fund transfer request and performs an initial determination of compliance or non-compliance with applicable gaming limits and gaming rules after receiving an approval of the fund transfer request from the financial network(s).

At block 922, the master gateway 120 makes an initial determination of whether the fund transfer request is compliant or non-compliant with the retrieved gaming limits and gaming rules based upon the transaction data associated with the fund transfer request, i.e. identity of patron making request, card used to make request, amount requested, time of request, and location of request, and the transactions related to the fund transfer request.

At block 924, the master gateway 120 transmits the initial determination of compliance or non-compliance, as well as the related transaction information and applicable gaming limits and gaming rules to the backend server 111 for an on-site determination of compliance or non-compliance.

At decision diamond 926, the backend server 111 performs an independent determination of whether the fund transfer request is compliant or non-compliant with the applicable gaming limits and gaming rules. The backend server 111 makes this compliance determination by comparing the received transaction data for transactions related to the fund transfer request and the applicable gaming limits and gaming rules in view of the temporal factors, geographic factors, and identity factors used to configure and define the gaming limits and gaming rules. This comparison can include totaling the value of the transactions related to the fund transfer request according to date, time, patron identity, card account, location of transaction, or any combination thereof.

If the backend server 111 determines that the fund transfer request is compliant with the applicable gaming limits and gaming rules, and this determination agrees with the master gateway initial determination, the method proceeds to block 928 in FIG. 9C. If the backend server 111 determines that the fund transfer request is non-compliant with the applicable gaming limits and gaming rules, and this determination agrees with the master gateway initial determination, the method proceeds to block 946 in FIG. 9D. However, if the backend server 111 determines either that the fund transfer request is compliant or non-compliant with the applicable gaming limits and gaming rules, but the determination does not agree with the master gateway initial determination, the method proceeds to block 944.

Referring to FIG. 9C, there is shown a continuation of the flowchart of the method 900 for initiating a transaction with the EFT terminal 108, 208. At block 928 the backend server 111 authorizes the master gateway 120 to submit the fund transfer request to a financial network(s) for processing.

At block 930 the master gateway 120 sends the fund transfer request to a financial network(s) via a secure data communication connection and the response is received directly by the master gateway 120 from the financial network(s).

At decision diamond 932, the master gateway 120 receives either an approval or a disapproval for the fund transfer request from the financial network(s). Once the transaction request has been processed, the results of the transaction request are provided to the master gateway 120 from the appropriate financial server via the established interbank and financial network(s). Thus, if the transaction is approved, the method proceeds to block 922. And, if the transaction is declined at decision diamond 932, the method proceeds to block 946.

At block 934 the master gateway 120 passes the approved transaction record to the backend server 111. And at block 936 the backend server 111 submits the approved transaction record to the CMS and/or SAS 224 for creation of a corresponding transaction record in a database associated with the CMS and/or SAS 224. The transaction record stored in the database may include a time, date, amount, location, and patron identity.

At block 638 the CMS and/or SAS 224 generates a transaction authorization associated with the value of the fund transfer and transmits this transaction authorization to the backend server 111.

Referring to FIG. 9D, there is shown a continuation of the flowchart of the method 900 for initiating a transaction with the EFT terminal 108, 208. At block 940 the backend server 111 transmits the transaction authorization and an “APPROVED” transaction message along either Path A or Path B back to the EFT terminal from which the fund transfer request was originally made. When the fund transfer request was originally created through Path A, the backend server 111 transmits the transaction authorization and the “APPROVED” transaction message through the aggregator 218 to the EFT terminal from which the patron made the fund transfer request. The EFT terminal then displays the “APPROVED” transaction message to the patron. When the fund transfer request was originally created through Path B, the backend server 111 transmits the transaction authorization and the “APPROVED” transaction message through the controller 102 and wireless communications module 110, 210 to the EFT terminal from which the patron made the fund transfer request. As with Path A, the EFT terminal then displays the “APPROVED” transaction message to the patron.

At block 942 the backend server 111 transmits the transaction authorization to the table mounted display. As with block 940 this transmission path varies depending on whether the fund transfer request was originally made along Path A or Path B. When the fund transfer request was originally created through Path A, the backend server 111 transmits the transaction authorization to the table mounted display via the aggregator 218 and the EFT terminal 108, 208. When the fund transfer request was originally created through Path B, the backend server 111 transmits the transaction authorization to the table mounted display via the controller 102. When either Path A or Path B was utilized, the dealer or other casino employee then confirms the transaction by making or inputting a selection confirming the transaction at the display, i.e. by touching a touchscreen, prior to dispensing chips or other physical indicia to the patron at the table and terminating the method 900.

In some table game embodiments, when a transaction is approved, the printer 104 generates a printed record operating as an indicia of value that is received by the dealer. The dealer then provides the player with the appropriate number of chips. The dealer then takes the printed record operating as an indicia of value and places it within a cash chute at a respective table game. Thus, the cash chute receives cash and the printed record operating as an indicia of value printed by the printer box 106 or an on board printer of a handheld EFT terminal. In other embodiments, when a transaction is approved, the controller transmits the authorization to a table game display. The display presents an indication of the authorized EFT, which the dealer can confirm, i.e. by selecting or touching a confirmation/selection icon on the display.

In yet another embodiment, in lieu of providing the printed record operating as an indicia of value to an attendant of the establishment, the transactional system 100, 200 may issue an electronic credit to the establishment on behalf of the player. The value of the authorized electronic credit would then be remitted to the patron by an attendant of the establishment in some manner advantageous to the patron, including but not limited to cash, gaming chips, game play tokens, merchandise, services, or the like. The value may be remitted to the patron in any combination of the forms described above or in any other form desired by or acceptable to the patron, which collectively equals the value of the authorized electronic credit. As with the printed record operating as an indicia of value, the electronic credit is not dispensed directly to the patron but to the establishment or a designated attendant thereof for redemption and subsequent remittance to the patron.

Referring back to decision diamond 926 in FIG. 9B, if the backend server 111 determines either that the fund transfer request is compliant or non-compliant with the applicable gaming limits and gaming rules, but the determination of the backend server 111 does not agree with the initial determination of the master gateway 120, the method proceeds to block 944. At block 944 the fund transfer request is terminated, the system administrator is notified of the inconsistent determinations, which are flagged for later review, and an error message is presented to the patron via the EFT terminal explaining that the fund transfer request was terminated due to a system error.

Again referring back to decision diamond 926 in FIG. 9B, if the backend server 111 determines that the fund transfer request is non-compliant with the applicable gaming limits and gaming rules, and this determination agrees with the master gateway initial determination, the method proceeds to block 946 in FIG. 9C.

Referring back to FIG. 9C, at block 946 the backend server 111 terminates the fund transfer request and sends a “DECLINED” transaction message to the patron via the aggregator 218, wireless communication module 210, and EFT terminal 208. The “DECLINED” transaction message is displayed to the patron on the EFT terminal. The particular declination message can include details about the declination, such as the gaming limit(s) or gaming rule(s) with which the patron's fund transfer request was non-compliant, codes corresponding to the reason for non-compliance, as well as times, locations, or amounts that would result in compliant fund transfer requests.

For example, if the transaction is declined, a data packet is sent to the EFT terminal to inform the patron via a LCD display on the EFT terminal that the transaction was not approved. Further a similar data packet is sent to the table mounted display to inform the dealer or casino employee that the transaction was not approved. Additionally, if the transaction has been declined, the patron receives notification of the unsuccessful result and may be prompted to repeat the process, possibly using a different account.

The method then proceeds to block 948, where an examination of the declined transaction is performed. At block 950, any correctible errors are corrected. Thus, each transaction record can be examined to determine the error, and then a determination of whether the error can either be automatically or manually corrected is made.

At block 952, the illustrative backend server 111 is updated to reflect any errors that have or have not been corrected. By way of example and not of limitation, after the transaction is declined, the appropriate errors or error corrections are reported and all software reverts back to the initial state and waits for the next transaction. The method then proceeds to block 954 where the transactional system is prepared for the next transaction.

Referring back to decision diamond 932 in FIG. 9C, if the transaction is declined at decision diamond 932, the method proceeds to block 946. At block 946 the backend server 111 terminates the fund transfer request and sends a “DECLINED” transaction message to the patron via the wireless communication module 110, and EFT terminal 108. The “DECLINED” transaction message is displayed to the patron on the EFT terminal. The backend server 111 also sends a “DECLINED” transaction message to the dealer or other casino employee via the wireless communication module 110, and then displayed on a table mounted display. The particular declination message can include details about the declination, such as any reason or denial code provide by the financial network(s).

The transactional system and method described above may be used at a table game. The transactional system and method may also be utilized independently of any existing in-house data, communication, or financial network(s), including but not limited to a CMS and/or SAS 224. The accounting and financial reconciliation functions of the transactional system and method are configured to be exported to, combined with, or merged into any existing or envisioned CMS and/or SAS 224 provided by the establishment. However, CMS infrastructure is not required to be fully functional. Thus, the transactional system and method may be installed and operated, without the need for a CMS, an ERP system, or other such backend systems.

The transactional system and method provides a high level of security. More specifically, the transactional system and method provides a high level of electronic security for the end user's sensitive financial information. Additionally, the transactional system and method enables authorized personnel, e.g. system administrators, to manage and monitor the system remotely using standard computing hardware. Furthermore, the transactional system and method includes modular software and hardware components that support the system functionality with secure software and firmware. Further still, the transactional system and method utilizes secure firmware and software of the various components and sub-systems, and procuring any necessary approvals will be greatly simplified when compared with a system utilizing proprietary hardware devices.

The degree of software modularity for the transactional system may easily evolve as well to benefit from the improved performance and anticipated lower cost of the required hardware components.

The transactional system and method provides a high level of security. More specifically, the transactional system and method provides a high level of electronic security for the end user's sensitive financial information. Additionally, the transactional system and method enables authorized personnel, e.g. system administrators, to manage and monitor the system remotely using standard computing hardware. Furthermore, the transactional system and method includes modular software and hardware components that support the system functionality with secure software and firmware. Further still, the transactional system and method utilizes secure firmware and software of the various components and sub-systems, and procuring any necessary approvals will be greatly simplified when compared with a system utilizing proprietary hardware devices.

It is to be understood that the detailed description of illustrative embodiments are provided for illustrative purposes. Thus, the degree of software modularity for the transactional system and method presented above may evolve to benefit from the improved performance and lower cost of the future hardware components that meet the system and method requirements presented. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A transactional system for a table game comprising:
a networkable component communicatively coupled to a Casino Management System (CMS), a financial network, and an electronic funds transfer (EFT) terminal, wherein the networkable component transmits a fund transfer request received from the EFT terminal to the financial network, and wherein the EFT terminal is associated with the table game;
at least one configurable gaming limit associated with the networkable component, wherein the networkable component is communicatively coupled to a database that includes a plurality of transaction information;
the networkable component retrieves the transaction information related to the fund transfer request;
the networkable component determines that the fund transfer request complies with the configurable gaming limit and transmits the transaction information for a compliant fund transfer request to the CMS; and
the networkable component transmits a fund transfer request approval message to the EFT terminal when the fund transfer request complies with the configurable gaming limit.

2. The transactional system of claim 1 wherein the CMS transmits an authorization message to the networkable component;
the authorization message corresponds to the transaction information for the compliant fund transfer request; and
the networkable component transmits the authorization message to the EFT terminal.

3. The transactional system of claim 2 wherein the networkable component includes, a master gateway and a backend server.

4. The transactional system of claim 3 wherein the master gateway includes a plurality of configurable gaming limits including the at least one configurable property limit, at least one of a federal gaming rule, a state gaming rule, a tribal gaming rule, and a problem gaming rule.

5. The transactional system of claim 1 wherein transaction information includes an EFT terminal identification, a financial transaction identification, a cardholder name, and a transaction value, a date and time, and a transaction location.

6. The transactional system of claim 3 wherein the master gateway further performs an initial determination that the fund transfer request complies with the at least one configurable gaming limit, and wherein the master gateway transmits the initial determination to the backend server.

7. The transactional system of claim 1 wherein the EFT terminal includes a Point-of-Sale (POS) terminal that receives the fund transfer request from a patron at one of a display and keypad; and
wherein the EFT terminal further displays the approval message for the compliant fund transfer request and a disapproval message for a non-compliant fund transfer request.

8. The transactional system of claim 7 wherein the table game further comprises:
a wireless communication module communicatively coupled to the EFT terminal;
an aggregator communicatively coupled to the wireless communication module and communicatively coupled to the networkable component;
a controller communicatively coupled to the wireless communication module;
wherein the controller receives the fund transfer request from the EFT terminal and transmits the fund transfer request to the wireless communication module;
wherein the wireless communication module transmits the fund transfer request to the aggregator; and
wherein the aggregator transmits the fund transfer request to the networkable component.

9. The transactional system of claim 8 wherein the wireless communications module enables communications with at least one other wireless communication module over short distances using point to point or broadcast packets that allow for bidirectional data transmission between each EFT terminal located on a casino gaming floor.

10. A transactional method for a table game, the transactional method comprising:
receiving, by an electronic funds transfer (EFT) terminal, a patron input corresponding to a fund transfer request, wherein the EFT terminal corresponds to the table game;
transmitting, by the EFT terminal, the fund transfer request to a networkable component communicatively coupled to the EFT terminal;
retrieving, by the networkable component, transaction information related to the fund transfer request and at least one configurable gaming limit from a database communicatively coupled to the networkable component;
determining, by the networkable component, that the fund transfer request complies with the at least one configurable gaming limit; and
transmitting, by the networkable component, transaction information corresponding to the fund transfer request that complies with the at least one configurable gaming limit to a Casino Management System (CMS) that is communicatively coupled to the networkable component.

11. The transactional method of claim 10 further comprising:
transmitting, by the CMS, an authorization message to the networkable component, wherein the authorization message corresponds to the transaction information transmitted by the networkable component; and
transmitting, by the networkable component, the authorization message to the EFT terminal.

12. The transactional method of claim 10 wherein the networkable component includes a master gateway and a backend server.

13. The transactional method of claim 12 wherein the master gateway includes a plurality of configurable gaming limits including the at least one configurable property limit, at least one of a federal gaming rule, a state gaming rule, a tribal gaming rule, and a problem gaming rule.

14. The transactional method of claim 10 wherein transaction information includes an EFT terminal identification, a financial transaction identification, a cardholder name, and a transaction value, a date and time, and a transaction location.

15. The transactional method of claim 12 further comprising:
performing an initial determination, by the master gateway, that the fund transfer request complies with the at least one configurable gaming limit; and
transmitting, by the master gateway, the initial determination to the backend server.

16. The transactional method of claim 10 further comprising displaying, by a Point-of-Sale (POS) terminal, an approval message for the fund transfer request that complies with the at least one configurable gaming limit, wherein the EFT terminal includes the POS terminal.

17. The transactional method of claim 10 further comprising:
determining, by the networkable component, that the fund transfer request does not comply with the at least one configurable gaming limit; and
transmitting, by the networkable component, a fund transfer request disapproval message to the electronic funds transfer terminal.

18. The transactional method of claim 17 further comprising displaying, by a Point-of-Sale (POS) terminal, a disapproval message for the fund transfer request that does not comply with the at least one configurable gaming limit, wherein the EFT terminal includes the POS terminal.

19. The transactional method of claim 12 wherein the EFT terminal transmits the fund transfer request to the backend server through a controller and a wireless communications module, the method further comprising:
transmitting, by the EFT terminal, the fund transfer request to the controller, wherein the controller is communicatively coupled to the EFT terminal;
transmitting, by the controller, the fund transfer request to the wireless communications module, wherein the controller is electrically coupled to the wireless communications module; and
transmitting, by the wireless communications module, the fund transfer request to the backend server, wherein the wireless communications module is communicatively coupled to the backend server, and wherein the wireless communications module enables communications with at least one other wireless communication module over short distances using point to point or broadcast packets that allow for bidirectional data transmission between each client device located on a casino gaming floor.

20. A transactional system for a table game comprising:
a networkable component communicatively coupled to a financial network, and an electronic funds transfer (EFT) terminal, wherein the networkable component transmits a fund transfer request received from the EFT terminal to the financial network, and wherein the EFT terminal is associated with the table game;
at least one configurable gaming limit associated with the networkable component, wherein the networkable component is communicatively coupled to a database that includes a plurality of transaction information;
the networkable component retrieves the transaction information related to the fund transfer request;
the networkable component determines that the fund transfer request complies with the configurable gaming limit and transmits the transaction information for a compliant fund transfer request to the networkable component; and
the networkable component transmits a fund transfer request approval message to the EFT terminal when the fund transfer request complies with the configurable gaming limit.
